(19) United States
(12) Patent Application Publication
(10) Pub. No.: US 2025/0393055 A1
(43) Pub. Date: Dec. 25, 2025

(54) DOWNLINK CONTROL INFORMATION SIZE-DEPENDENT AGGREGATION LEVELS

(71) Applicant: QUALCOMM Incorporated, San Diego, CA (US)

(72) Inventors: Mostafa KHOSHNEVISAN, San Diego, CA (US); Wei YANG, San Diego, CA (US); Gabi SARKIS, San Diego, CA (US); Jing JIANG, San Diego, CA (US)

(21) Appl. No.: 18/753,166

(22) Filed: Jun. 25, 2024

(51) Int. Cl. H04W 72/231; H04W 72/0446; H04W 88/08

(52) U.S. Cl. CPC H04W 72/231; H04W 72/0446; H04W 88/08

(57) ABSTRACT

Methods, systems, and devices for wireless communications are described. A user equipment (UE) may receive one or more control messages configuring a set of multiple search space sets. Each search space set of the set of multiple search space sets may be associated with one or more downlink control information (DCI) formats and a set of physical downlink control channel (PDCCH) candidates per aggregation level. The UE may select, from the set of PDCCH candidates, a subset of PDCCH candidates based on a size of one or more DCI messages and one or more configuration associated with a range of coding rates. Methods for selecting the subset of PDCCH candidates are described. The UE may monitor one or more search space sets of the set of multiple search space sets based on the selected subset of PDCCH candidates.

### TECHNICAL FIELD

The following relates to wireless communications, including downlink control information (DCI) size-dependent aggregation levels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving one or more control messages configuring a set of multiple search space sets, where each search space set of the set of multiple search space sets is associated with one or more downlink control information (DCI) formats and a set of physical downlink control channel (PDCCH) candidates per aggregation level, selecting, from the set of PDCCH candidates, a subset of PDCCH candidates based on a size of one or more DCI messages and one or more configurations associated with a range of coding rates, and monitoring one or more search space sets of the set of multiple search space sets based on the selected subset of PDCCH candidates.

A UE for wireless communications is described. The UE may include one or more memories storing processor-executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the UE to receive one or more control messages configuring a set of multiple search space sets, where each search space set of the set of multiple search space sets is associated with one or more DCI formats and a set of PDCCH candidates per aggregation level, select, from the set of PDCCH candidates, a subset of PDCCH candidates based on a size of one or more DCI messages and one or more configurations associated with a range of coding rates, and monitor one or more search space sets of the set of multiple search space sets based on the selected subset of PDCCH candidates.

Another UE for wireless communications is described. The UE may include means for receiving one or more control messages configuring a set of multiple search space sets, where each search space set of the set of multiple search space sets is associated with one or more DCI formats and a set of PDCCH candidates per aggregation level, means for selecting, from the set of PDCCH candidates, a subset of PDCCH candidates based on a size of one or more DCI messages and one or more configurations associated with a range of coding rates, and means for monitoring one or more search space sets of the set of multiple search space sets based on the selected subset of PDCCH candidates.

A non-transitory computer-readable medium storing code for wireless communications is described. The code may include instructions executable by one or more processors (e.g., directly, indirectly, after pre-processing, without pre-processing) to receive one or more control messages configuring a set of multiple search space sets, where each search space set of the set of multiple search space sets is associated with one or more DCI formats and a set of PDCCH candidates per aggregation level, select, from the set of PDCCH candidates, a subset of PDCCH candidates based on a size of one or more DCI messages and one or more configurations associated with a range of coding rates, and monitor one or more search space sets of the set of multiple search space sets based on the selected subset of PDCCH candidates.

In some examples of the method, UEs, and non-transitory computer-readable medium described herein, selecting the subset of PDCCH candidates may include operations, features, means, or instructions for selecting the subset of PDCCH candidates for each time interval of one or more time intervals, where each time interval includes a PDCCH monitoring occasion of a search space set of the set of multiple search space sets, a slot, a time interval including one or more PDCCH monitoring occasions, or a combination thereof.

In some examples of the method, UEs, and non-transitory computer-readable medium described herein, selecting the subset of PDCCH candidates may include operations, features, means, or instructions for selecting the subset of PDCCH candidates for each DCI format of one or more DCI formats that the UE may be to monitor in the one or more search space sets of the set of multiple search space sets.

Some examples of the method, UEs, and non-transitory computer-readable medium described herein may further include operations, features, means, or instructions for receiving control signaling that modifies the size of the one or more DCI messages associated with a DCI format, where selecting the subset of PDCCH candidates may be based on the control signaling.

In some examples of the method, UEs, and non-transitory computer-readable medium described herein, selecting the subset of PDCCH candidates may include operations, features, means, or instructions for selecting the subset of PDCCH candidates to include one or more PDCCH candidates associated with an aggregation level that may be greater than or equal to a threshold quantity of control channel elements (CCEs), where the threshold quantity of CCEs may be based on a DCI size, a threshold coding rate associated with the range of coding rates, and a quantity of coded bits per CCE.

In some examples of the method, UEs, and non-transitory computer-readable medium described herein, selecting the subset of PDCCH candidates may include operations, features, means, or instructions for selecting the subset of PDCCH candidates to include one or more PDCCH candidates associated with an aggregation level that may be less than or equal to a threshold quantity of CCEs, where the threshold quantity of CCEs may be based on a DCI size, a threshold coding rate associated with the range of coding rates, and a quantity of coded bits per CCE.

In some examples of the method, UEs, and non-transitory computer-readable medium described herein, selecting the subset of PDCCH candidates may include operations, features, means, or instructions for selecting the subset of PDCCH candidates to include one or more PDCCH candidates associated with an aggregation level that may be less than or equal to a first threshold quantity of CCEs and that may be greater than or equal to a second threshold quantity of CCEs, where the first threshold quantity of CCEs may be based on a DCI size, a first threshold coding rate associated with the range of coding rates, and a quantity of coded bits per CCE, and where the second threshold quantity of CCEs may be based on the DCI size, a second threshold coding rate associated with the range of coding rates, and the quantity of coded bits per CCE.

In some examples of the method, UEs, and non-transitory computer-readable medium described herein, selecting the subset of PDCCH candidates may include operations, features, means, or instructions for selecting the subset of PDCCH candidates to include one or more PDCCH candidates based on a relationship between one or more aggregation levels associated with the one or more PDCCH candidates and a nominal quantity of CCEs, where the nominal quantity of CCEs may be based on a size of a payload of a DCI, a nominal coding rate, and a quantity of coded bits per CCE.

In some examples of the method, UEs, and non-transitory computer-readable medium described herein, the subset of PDCCH candidates includes one or more PDCCH candidates associated with a smallest aggregation level that may be greater than or equal to the nominal quantity of CCEs, one or more PDCCH candidates associated with a largest aggregation level that may be less than or equal to the nominal quantity of CCEs, one or more PDCCH candidates associated with one or more aggregation levels that may be closest to the nominal quantity of CCEs, or any combination thereof.

In some examples of the method, UEs, and non-transitory computer-readable medium described herein, selecting the subset of PDCCH candidates may include operations, features, means, or instructions for selecting the subset of PDCCH candidates based on a first limit to a quantity of PDCCH candidates in the subset of PDCCH candidates and a second limit to a quantity of CCEs in the subset of PDCCH candidates, where one or more PDCCH candidates may be excluded from the subset of PDCCH candidates based on a priority associated with the subset of PDCCH candidates.

Some examples of the method, UEs, and non-transitory computer-readable medium described herein may further include operations, features, means, or instructions for receiving one or more control messages configuring the first limit to the quantity of PDCCH candidates in the subset of PDCCH candidates, the second limit to the quantity of CCEs in the subset of PDCCH candidates, or both for each search space set of the set of multiple search space sets.

In some examples of the method, UEs, and non-transitory computer-readable medium described herein, the priority associated with the subset of PDCCH candidates may be based on an aggregation level for each PDCCH candidate of the subset of PDCCH candidates and based on a candidate index for each PDCCH candidate of the subset of PDCCH candidates.

Some examples of the method, UEs, and non-transitory computer-readable medium described herein may further include operations, features, means, or instructions for receiving one or more control messages configuring one or more parameters associated with the subset of PDCCH candidates, a first threshold coding rate, a second threshold coding rate, a nominal coding rate, or any combination thereof, where selecting the subset of PDCCH candidates may be based on the one or more control messages.

Some examples of the method, UEs, and non-transitory computer-readable medium described herein may further include operations, features, means, or instructions for transmitting an indication of a capability for selecting and monitoring for the subset of PDCCH candidates, where the subset of PDCCH candidates may be selected based on the capability.

A method for wireless communications by a network entity is described. The method may include outputting one or more control messages configuring a set of multiple search space sets, where each search space set of the set of multiple search space sets is associated with one or more DCI formats and a set of PDCCH candidates per aggregation level, selecting, from the set of PDCCH candidates, a subset of PDCCH candidates based on a size of one or more DCI messages and one or more configurations associated with a coding rate range, and outputting a DCI in a search space set of the set of multiple search space sets based on the selected subset of PDCCH candidates.

A network entity for wireless communications is described. The network entity may include one or more memories storing processor executable code, and one or more processors coupled with (e.g., operatively, communicatively, functionally, electronically, or electrically) the one or more memories. The one or more processors may individually or collectively be operable to execute the code (e.g., directly, indirectly, after pre-processing, without pre-processing) to cause the network entity to output one or more control messages configuring a set of multiple search space sets, where each search space set of the set of multiple search space sets is associated with one or more DCI formats and a set of PDCCH candidates per aggregation level, select, from the set of PDCCH candidates, a subset of PDCCH candidates based on a size of one or more DCI messages and one or more configurations associated with a coding rate range, and output a DCI in a search space set of the set of multiple search space sets based on the selected subset of PDCCH candidates.

Another network entity for wireless communications is described. The network entity may include means for outputting one or more control messages configuring a set of multiple search space sets, where each search space set of the set of multiple search space sets is associated with one or more DCI formats and a set of PDCCH candidates per aggregation level, means for selecting, from the set of PDCCH candidates, a subset of PDCCH candidates based on a size of one or more DCI messages and one or more configurations associated with a coding rate range, and means for outputting a DCI in a search space set of the set of multiple search space sets based on the selected subset of PDCCH candidates.

A non-transitory computer-readable medium storing code for wireless communications is described. The code may include instructions executable by one or more processors (e.g., directly, indirectly, after pre-processing, without pre-processing) to output one or more control messages configuring a set of multiple search space sets, where each search space set of the set of multiple search space sets is associated with one or more DCI formats and a set of PDCCH candidates per aggregation level, select, from the set of PDCCH candidates, a subset of PDCCH candidates based on a size of one or more DCI messages and one or more configurations associated with a coding rate range, and output a DCI in a search space set of the set of multiple search space sets based on the selected subset of PDCCH candidates.

In some examples of the method, network entities, and non-transitory computer-readable medium described herein, selecting the subset of PDCCH candidates may include operations, features, means, or instructions for selecting the subset of PDCCH candidates for each time interval of one or more time intervals, where each time interval includes a PDCCH monitoring occasion of a search space set of the set of multiple search space sets, a slot, a time interval including one or more PDCCH monitoring occasions, or a combination thereof.

In some examples of the method, network entities, and non-transitory computer-readable medium described herein, selecting the subset of PDCCH candidates may include operations, features, means, or instructions for selecting the subset of PDCCH candidates for each DCI format of the one or more DCI formats for the one or more search space sets of the set of multiple search space sets.

In some examples of the method, network entities, and non-transitory computer-readable medium described herein, selecting the subset of PDCCH candidates may include operations, features, means, or instructions for outputting control signaling that modifies the size of the one or more DCI messages associated with a DCI format, where selecting the subset of PDCCH candidates may be based on the control signaling.

In some examples of the method, network entities, and non-transitory computer-readable medium described herein, selecting the subset of PDCCH candidates may include operations, features, means, or instructions for selecting the subset of PDCCH candidates to include one or more PDCCH candidates associated with an aggregation level that may be greater than or equal to a threshold quantity of CCEs, where the threshold quantity of CCEs may be based on a DCI size, a threshold coding rate associated with the range of coding rates, and a quantity of coded bits per CCE.

In some examples of the method, network entities, and non-transitory computer-readable medium described herein, selecting the subset of PDCCH candidates may include operations, features, means, or instructions for selecting the subset of PDCCH candidates to include one or more PDCCH candidates associated with an aggregation level that may be less than or equal to a threshold quantity of CCEs, where the threshold quantity of CCEs may be based on a DCI size, a threshold coding rate associated with the range of coding rates, and a quantity of coded bits per CCE.

In some examples of the method, network entities, and non-transitory computer-readable medium described herein, selecting the subset of PDCCH candidates may include operations, features, means, or instructions for selecting the subset of PDCCH candidates to include one or more PDCCH candidates associated with an aggregation level that may be less than or equal to a first threshold quantity of CCEs and that may be greater than or equal to a second threshold quantity of CCEs, where the first threshold quantity of CCEs may be based on a DCI size, a first threshold coding rate associated with the range of coding rates, and a quantity of coded bits per CCE, and where the second threshold quantity of CCEs may be based on the DCI size, a second threshold coding rate associated with the range of coding rates, and the quantity of coded bits per CCE.

In some examples of the method, network entities, and non-transitory computer-readable medium described herein, selecting the subset of PDCCH candidates may include operations, features, means, or instructions for selecting the subset of PDCCH candidates to include one or more PDCCH candidates based on a relationship between one or more aggregation levels associated with the one or more PDCCH candidates and a nominal quantity of CCEs, where the nominal quantity of CCEs may be based on a size of a payload of a DCI, a nominal coding rate, and a quantity of coded bits per CCE.

In some examples of the method, network entities, and non-transitory computer-readable medium described herein, the subset of PDCCH candidates includes one or more PDCCH candidates associated with a smallest aggregation level that may be greater than or equal to the nominal quantity of CCEs, one or more PDCCH candidates associated with a largest aggregation level that may be less than or equal to the nominal quantity of CCEs, one or more PDCCH candidates associated with one or more aggregation levels that may be closest to the nominal quantity of CCEs, or any combination thereof.

In some examples of the method, network entities, and non-transitory computer-readable medium described herein, selecting the subset of PDCCH candidates may include operations, features, means, or instructions for selecting the subset of PDCCH candidates based on a first limit to a quantity of PDCCH candidates in the subset of PDCCH candidates and a second limit to a quantity of CCEs in the subset of PDCCH candidates, where one or more PDCCH candidates may be excluded from the subset of PDCCH candidates based on a priority associated with the subset of PDCCH candidates. Some examples of the method, network entities, and non-transitory computer-readable medium described herein may further include operations, features, means, or instructions for outputting one or more control messages configuring the first limit to the quantity of PDCCH candidates in the subset of PDCCH candidates, the second limit to the quantity of CCEs in the subset of PDCCH candidates, or both for each search space set of the set of multiple search space sets.

In some examples of the method, network entities, and non-transitory computer-readable medium described herein, the priority associated with the subset of PDCCH candidates may be based on an aggregation level for each PDCCH candidate of the subset of PDCCH candidates and based on a candidate index for each PDCCH candidate of the subset of PDCCH candidates.

Some examples of the method, network entities, and non-transitory computer-readable medium described herein may further include operations, features, means, or instructions for outputting one or more control messages configuring one or more parameters associated with the subset of PDCCH candidates, a first threshold coding rate, a second threshold coding rate, a nominal coding rate, or any combination thereof, where selecting the subset of PDCCH candidates may be based on the one or more control messages.

Some examples of the method, network entities, and non-transitory computer-readable medium described herein may further include operations, features, means, or instructions for obtaining an indication of a capability of a UE for selecting and monitoring for the subset of PDCCH candidates, where the subset of PDCCH candidates may be selected based on the capability of the UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports downlink control information (DCI) size-dependent aggregation levels in accordance with one or more aspects of the present disclosure.

FIG. 2 shows an example of a wireless communications system that supports DCI size-dependent aggregation levels in accordance with one or more aspects of the present disclosure.

FIG. 3 shows an example of a timing diagram that supports DCI size-dependent aggregation levels in accordance with one or more aspects of the present disclosure.

FIG. 4 shows an example of a process flow that supports DCI size-dependent aggregation levels in accordance with one or more aspects of the present disclosure.

FIGS. 5 and 6 show block diagrams of devices that support DCI size-dependent aggregation levels in accordance with one or more aspects of the present disclosure.

FIG. 7 shows a block diagram of a communications manager that supports DCI size-dependent aggregation levels in accordance with one or more aspects of the present disclosure.

FIG. 8 shows a diagram of a system including a device that supports DCI size-dependent aggregation levels in accordance with one or more aspects of the present disclosure.

FIGS. 9 and 10 show block diagrams of devices that support DCI size-dependent aggregation levels in accordance with one or more aspects of the present disclosure.

FIG. 11 shows a block diagram of a communications manager that supports DCI size-dependent aggregation levels in accordance with one or more aspects of the present disclosure.

FIG. 12 shows a diagram of a system including a device that supports DCI size-dependent aggregation levels in accordance with one or more aspects of the present disclosure.

FIGS. 13 through 16 show flowcharts illustrating methods that support DCI size-dependent aggregation levels in accordance with one or more aspects of the present disclosure.

### DETAILED DESCRIPTION

A network entity may configure a user equipment (UE) with one or more search space sets in which the UE is to monitor for downlink control information (DCI) transmitted via a physical downlink control channel (PDCCH). For example, the network entity may configure each search space set of the one or more search space sets with one or more DCI formats to monitor, as well as a set of PDCCH candidates per aggregation level (e.g., four PDCCH candidates for an aggregation level of two, two PDCCH candidates for an aggregation level of four, and two PDCCH candidates for an aggregation level of eight, among other examples). The aggregation level (e.g., the quantity of control channel elements (CCEs)) for a DCI may be based on a payload size of the DCI (e.g., a quantity of bits). However, in some cases, the size of the DCI may not be fixed in a given search space set. That is, the size of the DCI may be updated dynamically, may be different for each DCI format, or may be changed via a command. In such cases, it may be desirable to adapt the PDCCH candidates that the UE is to monitor based on the size of the DCI.

In accordance with the techniques described herein, a relatively reduced quantity of PDCCH candidates may be selected by a wireless device, where the quantity of PDCCH candidates may be based on a DCI size. For example, in some implementations, a UE may receive one or more control messages configuring a set of multiple search space sets. Each search space set may be associated with one or more DCI formats and a set of PDCCH candidates per aggregation level. The UE may select, from the set of multiple PDCCH candidates, a subset of PDCCH candidates based on a size of one or more DCI messages, based on one or more configurations associated with a range of coding rates, based on one or more other factors, or a combination thereof. The UE may monitor one or more search space sets of the set of multiple search space sets based on the selected subset of PDCCH candidates.

In some aspects, the UE may include one or more PDCCH candidates in the subset of PDCCH candidates based on a respective aggregation level associated with the one or more PDCCH candidates being less than or equal to a maximum quantity of CCEs, being greater than equal to a minimum quantity of CCEs, or both. The maximum quantity of CCEs may be based on the size of one or more DCI messages, a minimum coding rate, and a quantity of coded bits per CCE. The minimum quantity of CCEs may be based on the size of one or more DCI messages, a maximum coding rate, and a quantity of coded bits per CCE. In some examples, the UE may include one or more PDCCH candidates in the subset of PDCCH candidates based on a respective aggregation level associated with the one or more PDCCH candidates being close to a nominal quantity of CCEs that is based on a size of one or more DCI messages, a nominal coding rate, and a quantity of coded bits per CCE. For example, the UE may include a PDCCH candidate that is associated with an aggregation level that is a smallest aggregation level that is greater than or equal to the nominal quantity of CCEs, a PDCCH candidate that is associated with an aggregation level that is a largest aggregation level that is less than or equal to the nominal quantity of CCEs, or both.

Particular aspects of the subject matter described herein may be implemented to realize one or more potential advantages. The described techniques may provide for reduced processing, improved user experience related to reduced processing, reduced power consumption, reduced latency, more efficient utilization of communication resources, and longer battery life. For example, based on a DCI size and a configuration associated with a range of coding rates, the UE may refrain from monitoring one or more PDCCH candidates in the set of multiple PDCCH candidates that are not included in the subset of PDCCH candidates.

Aspects of the disclosure are initially described in the context of wireless communications systems. Aspects of the disclosure are then described in the context of a signaling diagram, a timing diagram, and a process flow. Aspects of the disclosure are further illustrated by and described with reference to apparatus diagrams, system diagrams, and flowcharts that relate to DCI size-dependent aggregation levels.

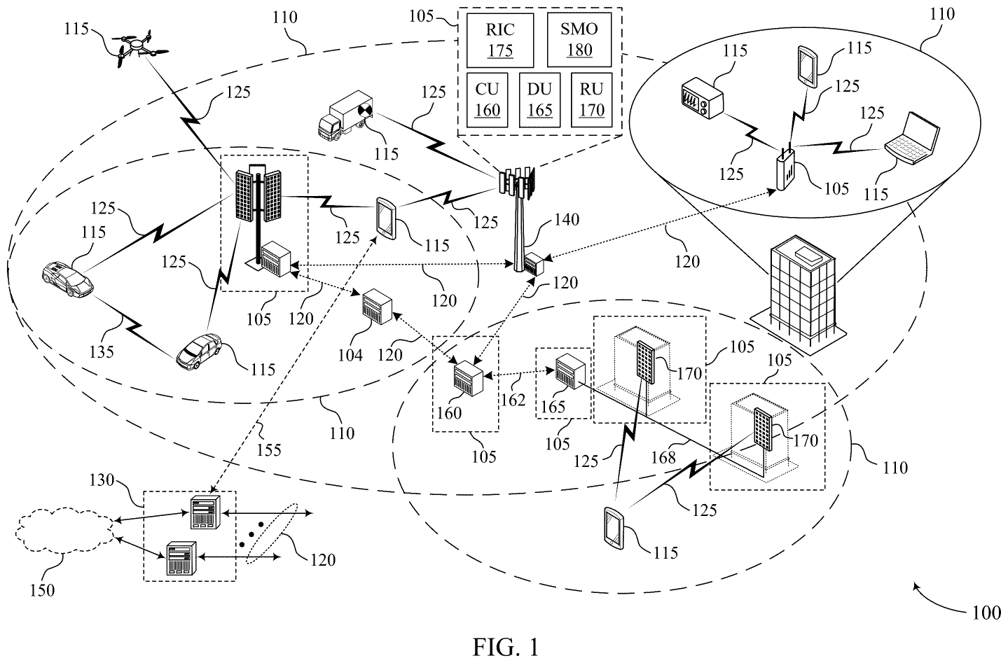

FIG. 1 shows an example of a wireless communications system 100 that supports DCI size-dependent aggregation levels in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system may include disclosure of the UE 115, network entity 105, apparatus, device, or computing system being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Ne may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., Nr) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., CCEs) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 may configure a UE 115 with one or more search space sets in which the UE 115 is to monitor for DCI on a PDCCH (e.g., via one or more communication links 125). For example, the network entity 105 may configure each search space set of the one or more search space sets with one or more DCI formats to monitor and a set of PDCCH candidates per aggregation level (e.g., four PDCCH candidates for an aggregation level of two, two PDCCH candidates for an aggregation level of four, and two PDCCH candidates for an aggregation level of eight). The aggregation level (e.g., the quantity of CCEs) for a DCI may be based on a payload size of the DCI (e.g., a quantity of bits). However, in some cases, the size of the DCI may not be fixed in a given search space set. That is, the size of the DCI may be updated dynamically, may be different for each DCI format, or may be changed via a command. In such cases, it may be desirable to narrow down the PDCCH candidates that the UE 115 is to monitor based on the size of the DCI.

The wireless communications system 100 may support techniques that enable the selection of a reduced or limited quantity of PDCCH candidates based on a size of one or more corresponding DCI, which may enhance communication efficiency in the wireless communications system 100 by adapting to various DCI sizes. In some implementations, a UE 115 may receive, via a communication link 125, one or more control messages configuring a set of multiple search space sets. Each search space set may be associated with one or more DCI formats and a set of PDCCH candidates per aggregation level. The UE 115 may select, from the set of multiple PDCCH candidates, a subset of PDCCH candidates based on a size of one or more DCI messages, based on one or more configurations associated with a range of coding rates, based on one or more other factors, or a combination thereof. The UE 115 may monitor one or more search space sets of the set of multiple search space sets based on the selected subset of PDCCH candidates.

For example, the UE 115 may include one or more PDCCH candidates in the subset of PDCCH candidates based on a respective aggregation level associated with the one or more PDCCH candidates being less than or equal to a maximum quantity of CCEs, being greater than equal to a minimum quantity of CCEs, or both. The maximum quantity of CCEs may be based on the size of one or more DCI messages, a minimum coding rate, and a quantity of coded bits per CCE. The minimum quantity of CCEs may be based on the size of one or more DCI messages, a maximum coding rate, and a quantity of coded bits per CCE. In some examples, the UE 115 may include one or more PDCCH candidates in the subset of PDCCH candidates based on a respective aggregation level associated with the one or more PDCCH candidates being close to a nominal quantity of CCEs that is based on a size of one or more DCI messages, a nominal coding rate, and a quantity of coded bits per CCE. For example, the UE 115 may include a PDCCH candidate that is associated with an aggregation level that is a smallest aggregation level that is greater than or equal to the nominal quantity of CCEs, a PDCCH candidate that is associated with an aggregation level that is a largest aggregation level that is less than or equal to the nominal quantity of CCEs, or both.

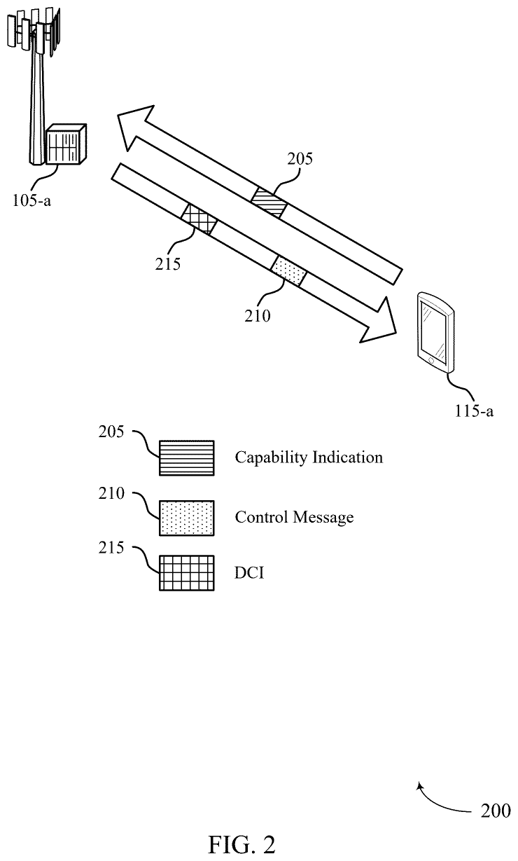

FIG. 2 shows an example of a wireless communications system 200 that supports DCI size-dependent aggregation levels in accordance with one or more aspects of the present disclosure. In some examples, the wireless communications system 200 may implement aspects of the wireless communications system 100. For example, the wireless communications system 200 includes a UE 115-a and a network entity 105-a, which may be examples of the corresponding devices described with reference to FIG. 1. Additionally, or alternatively, the UE 115-a and the network entity 105-a may each be examples of other types of wireless devices, such as an IAB node or another type of transmitter or receiver. Thus, although aspects of the present disclosure are described with reference to a UE 115 and a network entity 105, it is understood that the described techniques may be performed by a wireless device different from a UE 115 and a network entity 105. As described herein, operations performed by the UE 115-a and the network entity 105-a may be respectively performed by a UE 115, a network entity 105, or another wireless device, and the examples shown should not be construed as limiting.

Devices in the wireless communications system 200 may support the selection of a subset of PDCCH candidates for the UE 115-a to monitor (e.g., as indicated by the capability indication 205). In some examples, a UE (e.g., the UE 115-a) may be configured with a quantity (e.g., three or five) of CORESETs in a BWP of a serving cell. A PDCCH monitoring configuration may be based on one or more CORESETs and one or more search space sets. Each CORESET may be associated with a respective transmission configuration indication (TCI) state. As part of CORESET configurations, one or more resource blocks of a CORESET in the frequency domain and a quantity of symbols of a CORESET (e.g., 1, 2, or 3 OFDM symbols, or another duration of the CORESET) in the time domain may be RRC configured. Each search space set of a set of multiple search space sets may be associated with a respective CORESET, and there may be up to 10 search space sets in a BWP of a serving cell. As part of search space set configurations, the following may be RRC configured: a search space set index or identifier (ID), an associated CORESET ID, a periodicity and offset of one or more slots for the UE to monitor, one or more monitoring symbols associated with the one or more slots (e.g., which may determine one or more PDCCH monitoring occasions of the search space set), a search space set type (e.g., common search space (CSS) or UE-specific search space (USS)), one or more DCI formats for the UE to monitor, a quantity of PDCCH candidates for a given aggregation level (e.g., the UE 115-a may be configured with multiple aggregation levels), or any combination thereof.

One or more PDCCH candidates may be defined as part of search space set configurations. For example, a PDCCH candidate with a given aggregation level and a given candidate index may be defined in a given search space set. A DCI may be received in one PDCCH candidate. That is, the UE 115-a may monitor one or more PDCCH candidates in one or more search space sets, and the UE 115-a may decode one or more PDCCH candidates with a cyclic redundancy check (CRC) pass (e.g., successful decoding) corresponding to a decoded DCI, which the UE 115-a may blindly decode.

In some examples, the network entity 105-a may configure, via the control message 210, a search space set for the UE 115-a with one or more of aggregation level 1, aggregation level 2, aggregation level 4, aggregation level 8, and aggregation level 16, among other examples, where each aggregation level may be configured with one of 0, 1, 2, 3, 4, 5, 6, or 8 PDCCH candidates, among other examples. The network entity 105-a may configure, via the control message 210, a search space set type to be one of common or UE-specific. In some examples, (e.g., for a common search space set type and for DCI format 2_x (where x may be some integer)), there may be a separate configuration of the number (e.g., quantity) of candidates per each aggregation level for each DCI format. However, in some other examples (e.g., for a UE-specific search space set type), the quantity of PDCCH candidates per aggregation level may be configured for two or more formats (e.g., when formats0-0-And-1-0 is configured for fallback uplink and fallback downlink, or when formats0-1-And-1-1 is configured for non-fallback uplink and non-fallback downlink). That is, the quantity of PDCCH candidates per aggregation level may not be configured individually or separately for each DCI format. In one case, the network entity 105-a may be unable to configure a quantity of PDCCH candidates per aggregation level separately for DCI format 0_0 and for DCI format 1_0, because the configuration of PDCCH candidates per aggregation level is common to both DCI formats. In some examples, four DCI formats may share a common configuration for the quantity of PDCCH candidates per aggregation level (e.g., DCI formats 0_1 for non-fallback uplink, format 1_1 for non-fallback downlink, format 0_2 for non-fallback uplink, and format 1_2 for non-fallback downlink). However, it may be advantageous for the UE 115-a to monitor a different quantity of PDCCH candidates per aggregation level (or to monitor PDCCH candidates with different aggregation levels) in a given search space set for each DCI format (e.g., based on a DCI size).

In some examples, the network entity 105-a may perform DCI size alignment across two or more different DCI formats. For example, the size of uplink DCI and downlink DCI may be aligned in a common search space set. A first DCI size N1 of a fallback downlink DCI format 1_0 in a common search space set may be defined based on CORESET0 or on an initial uplink BWP. The network entity 105-a may zero-pad or truncate fallback uplink DCI format 0_0 in the common search space set based on the initial uplink BWP to match the first DCI size N1. A second DCI size N2 may be defined as the largest (e.g., the maximum value) out of the size of the fallback downlink DCI format 1_0 and the size of the fallback uplink DCI format 0_0 (e.g., in one or more UE-specific search space sets). The network entity 105-a may adjust the size of the smaller DCI format to match the second DCI size N2 based on an active downlink or uplink BWP. A third DCI size N3 of a non-fallback downlink DCI format 1_1 in a UE-specific search space set may be defined based on an active downlink BWP. If the third DCI size N3 is the same as the second DCI size N2, the network entity 105-a may increment the third DCI size N3 by one (e.g., so that the third DCI size N3 may be differentiated from the second DCI size N2). A fourth DCI size N4 of a non-fallback uplink DCI format 0_1 in a UE-specific search space set may be defined based on an active uplink BWP. If the fourth DCI size N4 is the same as the second DCI size N2, the network entity 105-a may increment the fourth DCI size N4 by one (e.g., so that the fourth DCI size N4 may be differentiated from the second DCI size N2).

In some cases, two or more of the DCI sizes may be the same (e.g., the second DCI size N2 may be the same as the first DCI size N1, or the fourth DCI size N4 may be the same as the third DCI size N3). However, if there are more than three different DCI sizes (e.g., unicast DCI messages) for a C-RNTI (e.g., each of the first DCI size N1, the second DCI size N2, the third DCI size N3, and the fourth DCI size N4 are different from each other), or if there are more than four DCI sizes overall (e.g., by considering other DCI formats 2_x in a common search space set for other RNTIs), the network entity 105-a may remove the 1-bit padding (if any) for the third DCI size N3 and the fourth DCI size N4 (e.g., reduce the third DCI size N3, the fourth DCI size N4, or both by 1) and set the second DCI size N2 equal to the first DCI size N1 (e.g., align N1 and N2). For DCI format 1_0 in a UE-specific search space set, the DCI size may be determined based on CORESET0, an initial downlink BWP, or both (e.g., instead of based on an active downlink BWP). In some cases, the network entity 105-a may zero-pad or truncate DCI format 0_0 in a UE-specific search space set based on an initial uplink BWP to match N2=N1.

For a given DCI format (e.g., associated with a given DCI size) that the UE 115-a may monitor in a given search space set, the network entity 105-a may configure a set of aggregation levels and a quantity of candidates for each aggregation level. For example, the network entity 105-a may configure 4 PDCCH candidates for aggregation level 2, 2 PDCCH candidates for aggregation level 4, and 2 PDCCH candidates for aggregation level 8 as part of search space set configurations. The network entity 105-a may select a given aggregation level and a given candidate index (e.g., a PDCCH candidate index) for each instance (e.g., monitoring occasion) of the search space set to send (e.g., transmit) the DCI. The aggregation level (e.g., a quantity of CCEs) for a DCI may be based on several factors, such as DCI size (e.g., a payload size of the DCI) and channel conditions (e.g., SINR). For example, a DCI message 215 with a relatively large payload size may be associated with a relatively larger aggregation level for the UE 115-a to decode the DCI message 215, or a relatively small SINR may be associated with a larger aggregation level in order for the UE 115-a to decode the DCI message 215. The network entity 105-a may select a candidate index (e.g., for a selected aggregation level) to pack more UEs or DCI messages in a given monitoring occasion. The ability to choose from multiple candidates may reduce a PDCCH blocking probability when multiple UEs are active. That is, the network entity 105-a may choose which of the PDCCH candidates to send the DCI message 215 on because each UE 115 may monitor the PDCCH candidates that the UE 115 is configured with.

If the DCI size is fixed for DCI messages monitored in a given search space set, the set of aggregation levels for the UE 115-a to monitor may be configured (e.g., RRC configured) as part of search space set configurations (e.g., as in NR). The set of aggregation levels may be based on a conservative estimate of channel conditions (e.g., a SINR range), as the set of aggregation levels may be semi-statically configured. For example, the aggregation level set may be {1, 2, 4} for cell-center UEs 115 and the aggregation level set may be {4, 8, 16} for cell-edge UEs 115. The network entity 105-a may dynamically select a candidate (e.g., a PDCCH candidate) with an aggregation level from the configured set of aggregation levels based on the channel (e.g., relatively short-term channel conditions), based on a packing of multiple DCI messages 215 associated with multiple UEs 115 into a monitoring occasion, or based on both.

However, there may be multiple scenarios (e.g., use cases) in which the DCI size is not fixed in a given search space set. For example, in a first use case, if DCI size alignment is done dynamically, the amount of zero-padding or truncating may change from one slot to the next for the same DCI format monitored in the same search space set (e.g., depending on the presence of other search space sets in a slot). Therefore, DCI size may not be constant in time for a given DCI format monitored in the search space set. In a second use case, it may be possible that multiple DCI formats with different DCI sizes may be configured for a given search space set, but the configuration of aggregation levels (e.g., the set of PDCCH candidates for the UE 115-a to monitor) may be common to all DCI formats. That is, respective DCI sizes may not be the same across multiple DCI formats. For example, when “formats0-1-And-1-1” is configured or when “formats0-1-And-1-1And-0-2-And-1-2” is configured, different DCI formats may have different sizes (e.g., depending on downlink and uplink BWP sizes and other RRC configurations that may impact the size of each DCI field in each DCI format), but PDCCH candidates may not be configured separately for these DCI formats. In a third use case, if a command (e.g., a medium access control-control element (MAC-CE) command or a DCI) results in a DCI size change for a given DCI format, then the DCI size may be different before and after application of the command (e.g., the network entity 105-a may transmit a control message 210 that varies a quantity of fields in the payload of the DCI message 215). In this case, RRC reconfigurations of the search space set may change the aggregation level or aggregation levels of PDCCH candidates. Such RRC reconfiguration may be slower than the command (e.g., compared to MAC-CE or DCI). For example, a MAC-CE may map multiple TCI states to a TCI codepoint (e.g., which may enable multiple transmission and reception point (mTRP) schemes using more DCI fields and resulting in increasing the DCI size). In another example, the network entity 105-a may output, to the UE 115-a, a control message 210 that modifies the size of one or more DCI messages associated with a DCI format. In each of the three use cases described, and in other use cases or examples in which the DCI size is not fixed (e.g., constant) in a given search space set, a method to narrow down the PDCCH candidates that the UE 115-a monitors (e.g., with respect to the aggregation levels of the PDCCH candidates) based on the DCI size may be desired.

In some implementations, the network entity 105-a may output or transmit, and the UE 115-a may receive, one or more control messages 210 configuring a set of multiple search space sets. Each search space set of the set of multiple search space sets may be associated with one or more DCI formats and a set of PDCCH candidates per aggregation level. From the set of PDCCH candidates configured for a given search space set, the UE 115-a (e.g., or the network entity 105-a) may determine (e.g., select) a subset of PDCCH candidates based on a size of one or more DCI messages 215 (e.g., a size of the payload of the DCI message 215) and based on one or more configurations associated with a range of coding rates. The code rate (e.g., coding rate) may be a ratio between the payload of the DCI message 215 and a quantity of CCEs (e.g., a quantity of resources that the UE 115-a may use). The quantity of CCEs may determine how many coded bits the UE 115-a can have, and the code rate may be the ratio between the DCI size (e.g., a quantity of information bits) and the number of coded bits. The subset of PDCCH candidates may be determined (e.g., selected) based on a subset of aggregation levels. For example, there may be a relatively increased importance of the aggregation level itself, rather than a candidate index within an aggregation level.

The determination of the subset of PDCCH candidates may be performed based on one or more other factors. In some examples, the subset of PDCCH candidates may be selected per PDCCH monitoring occasion of the search space set, per slot, or per a time interval in which one or more PDCCH monitoring occasions exist. This may be applicable to the first use case described herein, where the DCI size for a given DCI format monitored in the search space set may change from one time interval to another time interval. Hence, the subset of PDCCH candidates that the UE 115-a monitors may change from one time interval to another time interval. In some examples, the subset of PDCCH candidates may be selected per DCI format that the UE 115-a may monitor in the search space set. This may be applicable to the second use case described herein, where the UE 115-a may monitor multiple DCI formats with different DCI sizes in the search space set, but the configuration of the set of PDCCH candidates may be common to all of the multiple DCI formats. The determination of the subset of PDCCH candidates (e.g., the UE 115-a or the network entity 105-a selecting the subset of PDCCH candidates) may narrow down the candidates that the UE 115-a may monitor for each DCI format based on its DCI size. In some examples, the subset of PDCCH candidates may be selected after (e.g., based on, in response to) a command (e.g., a MAC-CE command) that changes the DCI size for a given DCI format monitored in the search space set. This may be applicable to the third use case described herein, where the DCI size (e.g., a size of a payload of the DCI message 215) may be changed dynamically. In this case, the subset of PDCCH candidates that the UE 115-a may monitor may change after the command is applied.

The determination (e.g., selection) of the subset of PDCCH candidates may be based on whether the corresponding aggregation level is within a range based on the DCI size and the coding rate range (e.g., a range of coding rates). In a first example, the UE 115-a or the network entity 105-a may select the subset of PDCCH candidates to include one or more PDCCH candidates associated with an aggregation level that is greater than or equal to a threshold quantity of CCEs, where the threshold quantity of CCEs may be based on a DCI size (e.g., the size of the DCI message 215), a threshold coding rate associated with the range of coding rates, and a quantity of coded bits per CCE. That is, one configuration for a maximum code rate (e.g., rₘₐₓ, or a first threshold coding rate that may be RRC configured, for example, per search space set) may determine a minimum number of CCEs (e.g.,

$${N}_{min}^{CCE} ,$$

or a first threshold quantity of CCEs) such that the condition of Equation 1 is satisfied. In Equation 1,

$${N}_{DCI}^{size}$$

may denote the size of the payload of the DCI message 215 (e.g., including CRC) and N_{CCE}^{codedbits} may represent a number or quantity of coded bits per CCE, excluding DMRS (e.g., 6 resource blocks per CCE times 9 non-DMRS per resource elements times 2 for a total of

$${N}_{C C E}^{codedbits} = 108$$

coded bits per CCE). In this example, any PDCCH candidate with an aggregation level greater than or equal to

$${N}_{min}^{CCE} ( e . g . , AL \geq {N}_{min}^{CCE} )$$

may belong to the subset of PDCCH candidates.

$${N}_{DCI}^{size} \leq {N}_{min}^{CCE} \cdot {r}_{max} \cdot {N}_{CCE}^{codedbits} \qquad ( 1 )$$

In a second example, the UE 115-a or the network entity 105-a may select the subset of PDCCH candidates to include one or more PDCCH candidates associated with an aggregation level that is less than or equal to a threshold quantity of CCEs, where the threshold quantity of CCEs may be based on a DCI size (e.g., the size of the DCI message 215), a threshold coding rate associated with the range of coding rates, and a quantity of coded bits per CCE. That is, one configuration for a minimum code rate (e.g., rₘᵢₙ, or a second threshold coding rate) may determine a maximum number (e.g., quantity) of CCEs (e.g.,

$${N}_{max}^{CCE} ,$$

or a second threshold quantity of CCEs) such that Equation 2 holds true. In this case, any PDCCH candidate with an aggregation level less than or equal to

$${N}_{max}^{CCE} ( e . g . , AL \leq {N}_{max}^{CCE} )$$

may belong to the subset of PDCCH candidates.

$${N}_{DCI}^{size} \geq {N}_{max}^{CCE} \cdot {r}_{min} \cdot {N}_{CCE}^{codedbits} \qquad ( 2 )$$

In a third example, the UE 115-a or the network entity 105-a may select the subset of PDCCH candidates to include one or more PDCCH candidates associated with an aggregation level that is less than or equal to a first threshold quantity of CCEs and that is greater than or equal to a second threshold quantity of CCEs, where the first threshold quantity of CCEs may be based on a DCI size (e.g., the size of the DCI message 215), a first threshold coding rate associated with the range of coding rates, and a quantity of coded bits per CCE, and where the second threshold quantity of CCEs may be based on the DCI size, a second threshold coding rate associated with the range of coding rates, and the quantity of coded bits per CCE. That is, two configurations for a maximum code rate and a minimum code rate (e.g., rₘₐₓ and rₘᵢₙ, or the first threshold coding rate and the second threshold coding rate, or a range of coding rates) may determine a minimum and maximum number of CCEs

$$( e . g . , {N}_{min}^{CCE} and {N}_{max}^{CCE} ,$$

or the first threshold quantity of CCEs and the second threshold quantity of CCEs, or a range of quantities of CCEs) such that Equation 3 holds true. In this case, any PDCCH candidate with an aggregation level within the range of quantities of CCEs

$$( e . g . , {N}_{min}^{CCE} \leq AL \leq {N}_{max}^{CCE} ,$$

or greater than the first threshold quantity of CCEs and less than the second threshold quantity of CCEs) may belong to the subset of PDCCH candidates.

$${N}_{max}^{CCE} \cdot {r}_{min} \cdot {N}_{CCE}^{cocedbits} \leq {N}_{DCI}^{size} \leq {N}_{min}^{CCE} \cdot {r}_{max} \cdot {N}_{CCE}^{codedbits} \qquad ( 3 )$$

In a fourth example, the UE 115-a or the network entity 105-a may select the subset of PDCCH candidates to include one or more PDCCH candidates based on a relationship between one or more aggregation levels associated with the one or more PDCCH candidates and a nominal quantity of CCEs, where the nominal quantity of CCEs may be based on a size of a payload of the DCI message 215, a nominal coding rate, and a quantity of coded bits per CCE (e.g., which may be fixed, or may not be nominal). That is, one configuration for a nominal code rate (e.g., nominal) may such that Equation 4 holds true (e.g.,

$${N}_{nominal}^{CCE} ,$$

using a floor operation), Equation 5 holds true (e.g., a ceiling operation), or both Equation 4 and Equation 5 hold true. In this case, any PDCCH candidate with an aggregation level closest to

$${N}_{nominal}^{CCE}$$

may belong to the subset of PDCCH candidates. For example, the subset of PDCCH candidates may include the aggregation level with the smallest value of

$$\vert AL - {N}_{nominal}^{CCE} \vert ,$$

the smallest aggregation level where

$$AL \geq {N}_{nominal}^{CCE} ,$$

the largest aggregation level where

$$AL \leq {N}_{nominal}^{CCE} ,$$

the two aggregation levels in between

$${N}_{nominal}^{CCE} ,$$

or any combination thereof.

$${N}_{nominal}^{CCE} = ⌊ \frac{{N}_{DCI}^{size}}{{r}_{nominal} \cdot {N}_{CCE}^{codedbits}} ⌋ \qquad ( 4 )$$

$${N}_{nominal}^{CCE} = ⌈ \frac{{N}_{DCI}^{size}}{{r}_{nominal} \cdot {N}_{CCE}^{codedbits}} ⌉ \qquad ( 5 )$$

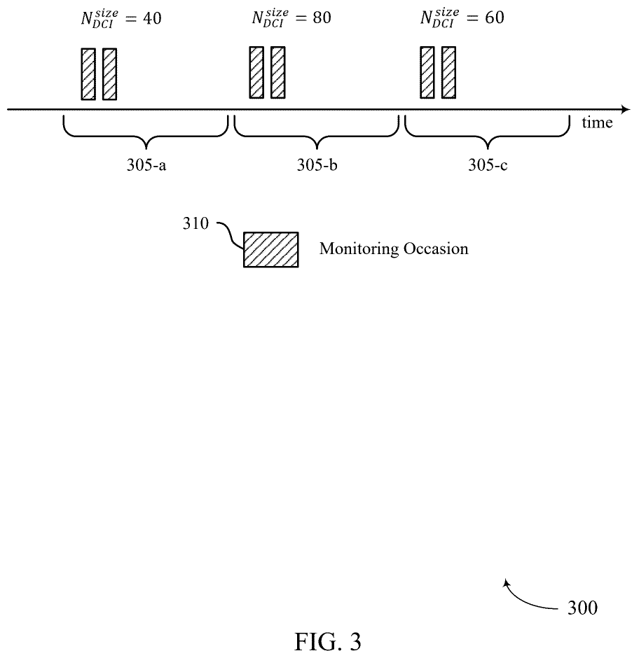

In any of the examples described herein, the values of the first threshold coding rate (e.g., rₘᵢₙ), the second threshold coding rate (e.g., rₘₐₓ), the nominal code rate (e.g., rₙₒₘᵢₙₐₗ), or any combination thereof, may be RRC configured (e.g., via the control message 210). For example, any combination of coding rates (e.g., associated with a range of coding rates) may be configured per serving cell, per BWP, per PDCCH-config (e.g., PDCCH configuration), per search space set, per CORESET, or any combination thereof, via the control message 210. An example timing diagram describing the subset of PDCCH candidates with each aggregation level for the first use case described herein and the third example associated with Equation 3 is described with reference to FIG. 3.

Determination (e.g., selection) of the subset of PDCCH candidates may be further based on a limit for the quantity of PDCCH candidates (e.g., a limit for the quantity of blind decodes (BDs)), or a limit for the quantity of CCEs defined for the search space set (e.g., RRC configured per search space set). That is, the UE 115-a or the network entity 105-a may select the subset of PDCCH candidates based on a first limit of a quantity of PDCCH candidates in the subset of PDCCH candidates and a second limit of a quantity of CCEs in the subset of PDCCH candidates. Note that the CCE limit (e.g., the second limit of the quantity of CCEs in the subset of PDCCH candidates) may be with respect to all CCEs of all candidates in the subset of PDCCH candidates, and should not be confused with the number of CCEs (e.g.,

$${N}_{min}^{CCE} and {N}_{max}^{CCE}$$

discussed with respect to Equations 1-5) determined based on the size of the DCI message 215 and the code rate range (e.g., associated with rₘᵢₙ, rₘₐₓ, rₙₒₘᵢₙₐₗ, or a combination thereof). Note also that the limits (e.g., the first limit of the quantity of PDCCH candidates in the subset of PDCCH candidates, the second limit of the quantity of CCEs in the subset of PDCCH candidates, or both) may be different from blind decode limits and CCE limits that are across all search space sets in a given slot. Rather, the limits described herein are specific to a given search space set. This additional factor may ensure that blind decodes or CCEs consumed by the search space set may be contained within the limits when the determination or selection of the subset of PDCCH candidates may change from one slot to another. That is, because the subset of PDCCH candidates may change from one time interval to the next, the UE 115-a may ensure that the quantity of PDCCH candidates and the quantity of CCEs that the UE 115-a monitors for a particular search space set does not involve too many PDCCH candidates or CCEs out of the overall budget for the UE 115-a. In some examples, the network entity 105-a may output or transmit, to the UE 115-a, a control message 210 that configures the first limit of the quantity of PDCCH candidates in the subset of PDCCH candidates, the second limit of the quantity of CCEs in the subset of PDCCH candidates, or both.

One or more PDCCH candidates may be excluded from the subset of PDCCH candidates based on a priority associated with the subset of PDCCH candidates. The priority may be on an aggregation level for each PDCCH candidate and the candidate index of each PDCCH candidate. For example, the UE 115-a may include one or more PDCCH candidates with

$$AL \geq {N}_{min}^{CCE}$$

in the subset of PDCCH candidates starting with the lowest aggregation level until the limit on the quantity of PDCCH candidates or CCEs (e.g., the first limit or the second limit) is reached. For a given aggregation level, the order (e.g., the priority with which PDCCH candidates are included in the subset of PDCCH candidates) may be based on a candidate index of each PDCCH candidate. In another example, the UE 115-a may include one or more PDCCH candidates with

$$AL \leq {N}_{max}^{CCE}$$

in the subset of PUCCH candidates starting with the highest aggregation level until the first limit on the quantity of PDCCH candidates is reached, the second limit on the quantity of CCEs is reached, or both. For a given aggregation level, the order may be based on a PDCCH candidate index. For the second limit on the number or quantity of CCEs, a CCE may be counted once (e.g., no more than once), even if the CCE belongs to multiple PDCCH candidates. Specific examples of selecting one or more PDCCH candidates to include in the subset of PDCCH candidates based on a priority and based on the first limit, the second limit, or both are described with reference to FIG. 3.

In some examples, this feature (e.g., selecting a subset of PDCCH candidates) may be configured, enabled, or both by RRC configuration, which may be per serving cell, per BWP (e.g., applied for all search space sets in a serving cell or BWP, or configured under PDCCH-Configuration, which is per BWP), per CORESET (e.g., applied for all search space sets associated with a CORESET), per search space set, or a combination thereof.

In some examples, the UE 115-a may indicate the support of this feature (e.g., selecting a subset of PDCCH candidates) through UE capability signaling. For example, the UE 115-a may transmit, and the network entity 105-a may obtain or receive, a capability indication 205 indicating that the UE 115-a is capable of selecting and monitoring for the subset of PDCCH candidates. In some cases, the UE 115-a may transmit the capability indication 205 before receiving the control message 210, and the UE 115-a, the network entity 105-a, or both may select the subset of PDCCH candidates based on the capability indication 205.

FIG. 3 shows an example of a timing diagram 300 that supports DCI size-dependent aggregation levels in accordance with one or more aspects of the present disclosure. The timing diagram 300 may implement or be implemented by one or more aspects of the wireless communications system 100 and the wireless communications system 200 described with reference to FIGS. 1 and 2, respectively. For example, the timing diagram 300 may be implemented by a network entity 105 and a UE 115 as described with reference to FIGS. 1 and 2 to support the selection of a subset of PDCCH candidates for the UE 115 to monitor for a DCI. FIG. 3 illustrates three example time intervals 305 (e.g., slots), which may each contain one or more monitoring occasions 310 in which a UE 115 may monitor for one or more DCI messages from a network entity 105. The examples described herein illustrate how a UE 115 may select a subset of PDCCH candidates, and should not be construed as limiting.

For example, the resource diagram 300 may be utilized in an example of the first use case described with reference to FIG. 2 in which the size of a DCI is not fixed for a given search space set. If DCI size alignment is done dynamically, the amount of zero-padding or truncating may change from one time interval 305 to another (e.g., from a first time interval 305-a to a second time interval 305-b, or from the second time interval 305-b to a third time interval 305-c) for the same DCI format monitored in the same search space set (e.g., depending on the presence of other search space sets in a slot). Therefore, DCI size may not be constant in time for a given DCI format monitored in the search space set.

For example, for a first DCI format and a first search space set, the DCI size

$$( {N}_{DCI}^{size} )$$

may be 40 (e.g., 40 bits) for the first time interval 305-a,

$${N}_{DCI}^{size} = 80$$

for the second time interval 305-b, and

$${N}_{DCI}^{size} = 60$$

for the third time interval 305-c. Each of the first time interval 305-a, the second time interval 305-b, and the third time interval 305-c may be configured with two monitoring occasions 310. In this example, the original set of PDCCH candidates configured for the first search space set (e.g., from which the subset of PDCCH candidates may be selected) may be as follows: 6 PDCCH candidates for a first aggregation level (AL=1), 4 PDCCH candidates for a second aggregation level (AL=2), 4 PDCCH candidates for a third aggregation level (AL=4), 2 PDCCH candidates for a fourth aggregation level (AL=8), and 1 PDCCH candidate for a fifth aggregation level (AL=16). The network entity 105 may configure a first threshold code rate (e.g., a minimum code rate) rₘᵢₙ=0.08 and a second threshold code rate (e.g., a maximum code rate) rₘₐₓ=0.5. As discussed with reference to FIG. 2, the quantity of coded bits per CCE may be, in an example,

$${N}_{CCE}^{codedbits} = 6 * 9 * 2 = 108 .$$

The UE 115 or the network entity 105 may include PDCCH candidates in the subset of PDCCH candidates that are associated with an aggregation level between a first threshold quantity of CCEs and a second threshold quantity of CCES (e.g.,

$${N}_{min}^{CCE} \leq AL \leq {N}_{max}^{CCE} ) .$$

the UE 115 and the network entity 105 may determine the values of Nₘᵢₙ^{CCE} and Nₘₐₓ^{CCE} using Equation 3 (reproduced below for convenience).

$${N}_{max}^{CCE} \cdot {r}_{min} \cdot {N}_{CCE}^{codedbits} \leq {N}_{DCI}^{size} \leq {N}_{min}^{CCE} \cdot {r}_{max} \cdot {N}_{CCE}^{codedbits} \qquad ( 3 )$$

For example, in the first time interval 305-a where

$${N}_{DCI}^{size} = 40 ,$$

the UE 115 or the network entity 105 may determine that

$${N}_{min}^{CCE} = 1 and {N}_{max}^{CCE} = 4 ,$$

as shown in Equation 6. The UE 115 or the network entity 105 may select, based on the DCI size and the one or more configurations associated with a range of coding rates, the subset of PDCCH candidates from the original set of PDCCH candidates for the first search space set as follows: 6 PDCCH candidates with AL=1, 4 PDCCH candidates with AL=2, and 4 PDCCH candidates with AL=4, for a total of 14 PDCCH candidates in the subset of PDCCH candidates. These PDCCH candidates may be included in the subset of PDCCH candidates associated with the first time interval 305-a based on the respective aggregation level having a value between

$${N}_{min}^{CCE} = 1 and {N}_{max}^{CCE} = 4 ,$$

inclusive, where those values were determined based on a configured coding rate range and a DCI size, as shown in Equations 3 and 6. For example, the PDCCH candidates associated with AL=1, AL=2, and AL=4 were included in the subset of PDCCH candidates because those PDCCH candidates were associated with aggregation levels from the original set of configured aggregation levels for the first search space set that met the criteria

$${N}_{min}^{CCE} \leq AL \leq {N}_{max}^{CCE} .$$

$${N}_{max}^{CCE} \cdot ( 0. 08 ) \cdot ( 108 ) \leq 40 \leq {N}_{min}^{CCE} \cdot ( 0.5 ) \cdot ( 108 ) \qquad ( 6 )$$

In the second time interval 305-b, the DCI size may be different from the DCI size in the first time interval 305-a. For example, the DCI may be different based on dynamic DCI size alignment (e.g., the first use case described with reference to FIG. 2), based on the DCI format being different from the first time interval 305-a to the second time interval 305-b but a common original set of aggregation levels for the first search space set is configured (e.g., the second use case described with reference to FIG. 2), based on receiving a command that results in a DCI size change (e.g., the third use case described with reference to FIG. 2), or a combination thereof. In the second time interval 305-b, where the new or updated DCI size may be

$${N}_{DCI}^{size} = 80 ,$$

the UL 115 or the network entity 105 may determine that

$${N}_{min}^{CCE} = 2 and {N}_{max}^{CCE} = 9 ,$$

as shown in Equation 7. The UE 115 or the network entity 105 may select, based on the DCI size and the one or more configurations associated with a range of coding rates, the subset of PDCCH candidates from the original set of PDCCH candidates for the first search space set as follows: 4 PDCCH candidates with AL=2, 4 PDCCH candidates with AL=4, and 2 PDCCH candidates with AL=8, for a total of 10 PDCCH candidates in the subset of PDCCH candidates. These PDCCH candidates may be included in the subset of PDCCH candidates associated with the second time interval 305-b based on the respective aggregation level having a value between

$${N}_{min}^{CCE} = 2 and {N}_{max}^{CCE} = 9 ,$$

inclusive, where those values were determined based on a configured coding rate range and a DCI size, as shown in Equations 3 and 7. For example, the PDCCH candidates associated with AL=2, AL=4, and AL=8 were included in the subset of PDCCH candidates because those PDCCH candidates were associated with aggregation levels from the original set of configured aggregation levels for the first search space set that met the criteria

$${N}_{min}^{CCE} \leq AL \leq {N}_{max}^{CCE} .$$

$${N}_{max}^{CCE} \cdot 0.08 \cdot 108 \leq 80 \leq {N}_{min}^{CCE} \cdot 0.5 \cdot 108 \qquad ( 7 )$$

In the third time interval 305-c, the DCI size may be different from the DCI size in the second time interval 305-b. For example, the DCI may be different based on dynamic DCI size alignment (e.g., the first use case described with reference to FIG. 2), based on the DCI format being different from the first time interval 305-a to the second time interval 305-b but a common original set of aggregation levels for the first search space set is configured (e.g., the second use case described with reference to FIG. 2), based on receiving a command that results in a DCI size change (e.g., the third use case described with reference to FIG. 2), or a combination thereof. In the third time interval 305-c, where the new or updated DCI size may be

$${N}_{DCI}^{size} = 60 ,$$

the UL 115 or the network entity 105 may determine that

$${N}_{min}^{CCE} = 2 and {N}_{max}^{CCE} = 6 ,$$

shown in Equation 8. The UE 115 or the network entity 105 may select, based on the DCI size and the one or more configurations associated with a range of coding rates, the subset of PDCCH candidates from the original set of PDCCH candidates for the first search space set as follows: 4 PDCCH candidates with AL=2 and 4 PDCCH candidates with AL=4, for a total of 8 PDCCH candidates in the subset of PDCCH candidates. These PDCCH candidates may be included in the subset of PDCCH candidates associated with the third time interval 305-c based on the respective aggregation level having a value between

$${N}_{min}^{CCE} = 2 and {N}_{max}^{CCE} = 6 ,$$

inclusive, where those values were determined based on a configured coding rate range and a DCI size, as shown in Equations 3 and 8. For example, the PDCCH candidates associated with AL=2 and AL=4 were included in the subset of PDCCH candidates because those PDCCH candidates were associated with aggregation levels from the original set of configured aggregation levels for the first search space set that met the criteria

$${N}_{min}^{CCE} \leq AL \leq {N}_{max}^{CCE} .$$

$${N}_{max}^{CCE} \cdot 0.08 \cdot 108 \leq 60 \leq {N}_{min}^{CCE} \cdot 0.5 \cdot 108 \qquad ( 8 )$$

An additional factor for determination (e.g., selection) of the subset of PDCCH candidates may be based on a limit for the quantity of PDCCH candidates (e.g., a limit for the quantity of BDs), or a limit for the quantity of CCEs defined for the first search space set (e.g., RRC configured per search space set). That is, the UE 115 or the network entity 105 may select the subset of PDCCH candidates based on a first limit of a quantity of PDCCH candidates in the subset of PDCCH candidates and a second limit of a quantity of CCEs in the subset of PDCCH candidates. Note that the CCE limit (e.g., the second limit of the quantity of CCEs in the subset of PDCCH candidates) may be with respect to all CCEs of all candidates in the subset of PDCCH candidates, and should not be confused with the number of CCEs (e.g.,

$${N}_{min}^{CCE} and {N}_{max}^{CCE}$$

discussed with respect to Equations 1-8) determined based on the DCI size

$${N}_{DCI}^{size}$$

and the code rate range (e.g., associated with rₘᵢₙ, rₘₐₓ, rₙₒₘᵢₙₐₗ, or a combination thereof). Note also that the limits (e.g., the first limit of the quantity of PDCCH candidates in the subset of PDCCH candidates, the second limit of the quantity of CCEs in the subset of PDCCH candidates, or both) may be different from blind decode limits and CCE limits that are across all search space sets in a given slot. Rather, the limits described herein are specific to a given search space set (e.g., the first search space set). This additional factor may ensure that blind decodes or CCEs consumed by the search space set may be contained within the limits when the determination or selection of the subset of PDCCH candidates may change from one slot to another (e.g., from the first time interval 305-a to the second time interval 305-b and from the second time interval 305-b to the third time interval 305-c). That is, because the subset of PDCCH candidates may change from one time interval 305 to the next, the UE 115, the network entity 105, or both may ensure that the quantity of PDCCH candidates and the quantity of CCEs that the UE 115 monitors for the first search space set does not involve too many PDCCH candidates or CCEs out of the overall budget for the UE 115. In some examples, the network entity 105 may output or transmit, to the UE 115, a control message that configures the first limit of the quantity of PDCCH candidates in the subset of PDCCH candidates, the second limit of the quantity of CCEs in the subset of PDCCH candidates, or both.

One or more PDCCH candidates may be excluded from the subset of PDCCH candidates based on a priority associated with the subset of PDCCH candidates. The priority may be on an aggregation level for each PDCCH candidate and the candidate index of each PDCCH candidate. For example, the UE 115 or the network entity 105 may include one or more PDCCH candidates with

$$AL \geq {N}_{min}^{CCE}$$

in the sunset of PDCCH candidates starting with the lowest aggregation level until the limit on the quantity of PDCCH candidates or CCEs (e.g., the first limit or the second limit) is reached. For a given aggregation level, the order (e.g., the priority with which PDCCH candidates are included in the subset of PDCCH candidates) may be based on a candidate index of each PDCCH candidate. In the example of the first time interval 305-a (e.g., with

$${N}_{DCI}^{size} = 40 and {N}_{min}^{CCE} = 1 ) ,$$

the network entity 105 may configure the first limit of the quantity of PDCCH candidates to be 9 PDCCH candidates. Based on the first limit and a configuration to include PDCCH candidates with

$$AL \geq {N}_{min}^{CCE}$$

in the subset of PDCCH candidates starting with the lowest aggregation level until the limit on the quantity of PDCCH candidates is reached, the UE 115 or the network entity 105 may include, in the subset of PDCCH candidates, 6 PDCCH candidates with AL=1 and 3 PDCCH candidates with AL=2 (e.g., 3 out of the 4 PDCCH candidates associated with AL=2 in the original set of PDCCH candidates for the first search space set). A fourth PDCCH candidate associated with AL=2 and all PDCCH candidates associated with AL=4, AL=8, and AL=16 may be excluded from the subset of PDCCH candidates because the first limit of 9 PDCCH candidates has already been reached. In this example, which of the four PDCCH candidates associated with AL=2 is excluded from the subset of PDCCH candidates may be based on a PDCCH candidate index.

In another example, the UE 115 may include one or more PDCCH candidates with

$$AL \leq {N}_{max}^{CCE}$$

in the sunset of PDCCH candidates starting with the highest aggregation level until the first limit on the quantity of PDCCH candidates is reached, the second limit on the quantity of CCEs is reached, or both. For a given aggregation level, the order may be based on a PDCCH candidate index. In the example of the first time interval 305-a (e.g., with

$${N}_{DCI}^{size} = 40 and {N}_{max}^{CCE} = 4 ) ,$$

the network entity 105 may configure the first limit of the quantity of PDCCH candidates to be 9 PDCCH candidates. Based on the first limit and a configuration to include PDCCH candidates with

$$AL \leq {N}_{max}^{CCE}$$

in the subset of PDCCH candidates starting with the highest aggregation level until the first limit on the quantity of PDCCH candidates is reached, the UE 115 or the network entity 105 may include, in the subset of PDCCH candidates, 4 PDCCH candidates with AL=4, 4 PDCCH candidates with AL=2, and 1 PDCCH candidate with AL=1 (e.g., the first PDCCH candidate out of the 6 PDCCH candidates associated with AL=1 in the original set of PDCCH candidates for the first search space set). 5 PDCCH candidates associated with AL=1 and all PDCCH candidates associated with AL=8 and AL=16 may be excluded from the subset of PDCCH candidates because the first limit of 9 PDCCH candidates has already been reached. In this example, which 5 of the 6 PDCCH candidates associated with AL=1 are excluded from the subset of PDCCH candidates may be based on a PDCCH candidate index.

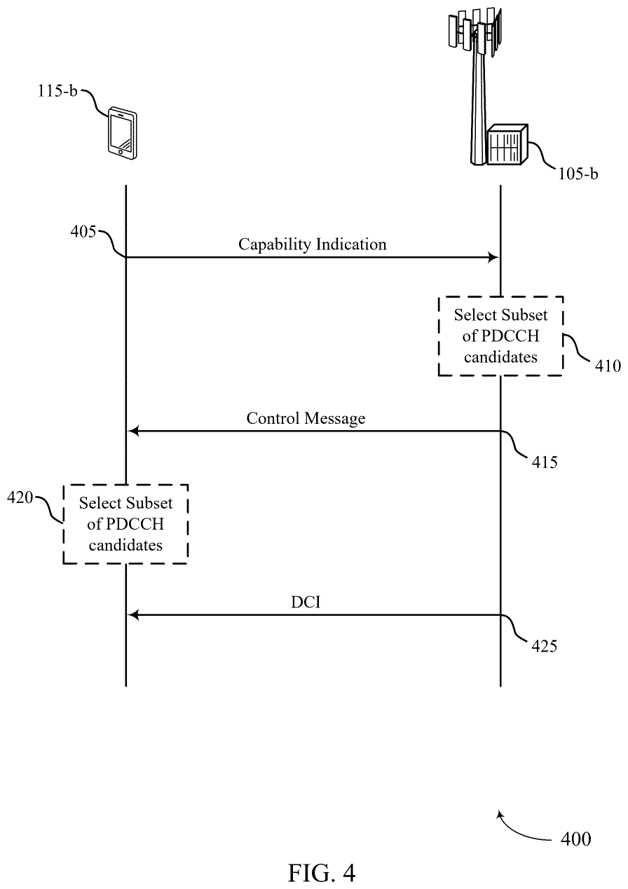

FIG. 4 shows an example of a process flow 400 that supports DCI size-dependent aggregation levels in accordance with one or more aspects of the present disclosure. In some examples, the process flow 400 may be implemented by, or may implement aspects of, the wireless communications system 100, the wireless communications system 200, and the timing diagram 300. For example, the process flow 400 includes a network entity 105-b and a UE 115-b, which may be examples of the corresponding devices described with reference to FIGS. 1 and 2. Following the process flow 400, the UE 115-b, the network entity 105-b, or both may select a subset of PDCCH candidates for the UE 115-b to monitor for a DCI. Alternative examples of the following may be implemented, where some steps are performed in a different order than described or are not performed at all. In some cases, steps may include additional features not mentioned below, or further steps may be added. Although the UE 115-b and the network entity 105-b are shown performing the operations of the process flow 400, some aspects of some operations may also be performed by one or more other wireless devices.

At 405, the UE 115-b may transmit, and the network entity 105-b may obtain or receive, an indication of a capability of the UE 115-b for selecting and monitoring for a subset of PDCCH candidates.

At 410, the network entity 105-b may select, from a set of PDCCH candidates, a subset of PDCCH candidates based on a size of one or more DCI messages and one or more configurations associated with a range of coding rates. For example, the network entity 105-b may select the subset of PDCCH candidates for each time interval of one or more time intervals (e.g., a time interval 305 as described in more detail with reference to FIG. 3). Each time interval may include a PDCCH monitoring occasion of a search space set of the set of multiple search space sets, one or more slots, a time interval comprising one or more PDCCH monitoring occasions, or a combination thereof.

In some examples, the network entity 105-b may select the subset of PDCCH candidates for each DCI format of one or more DCI formats that the UE 115-b is to monitor in the one or more search space sets of the set of multiple search space sets. Additionally, or alternatively, the network entity 105-b may select the subset of PDCCH candidates to include one or more PDCCH candidates associated with an aggregation level that is greater than or equal to a threshold quantity of CCEs (e.g., a minimum quantity of CCEs,

$${N}_{min}^{CCE} ) .$$

The threshold quantity of CCEs may be based on a DCI size (e.g.,

$${N}_{DCI}^{size} ) ,$$

a threshold coding rate associated with the range of coding rates (e.g., a maximum coding rate, rₘₐₓ), and a quantity of coded bits per CCE (e.g.,

$${N}_{CCE}^{codedbits} ) .$$

In some examples, the network entity 105-b may select the subset of PDCCH candidates to include one or more PDCCH candidates associated with an aggregation level that is less than or equal to a threshold quantity of CCEs (e.g., a maximum quantity of CCEs,

$${N}_{max}^{CCE} ) .$$

The threshold quantity or CCEs may be based on a DCI size (e.g.,

$${N}_{DCI}^{size} ) ,$$

a threshold coding rate associated with the range of coding rates (e.g., a minimum coding rate, rₘᵢₙ), and a quantity of coded bits per CCE (e.g.,

$${N}_{CCE}^{codedbits} ) .$$

In some examples, the network entity 105-b may select the subset of PDCCH candidates to include one or more PDCCH candidates associated with an aggregation level that is less than or equal to a first threshold quantity of CCEs (e.g., a maximum quantity of CCEs,

$${N}_{max}^{CCE} )$$

and that is greater than or equal to a second threshold quantity of CCEs (e.g., a minimum quantity of CCEs,

$${N}_{min}^{CCE} ) .$$

The first threshold quantity of CCEs may be based on a DCI size (e.g., N_{DCI}^{size}), a first threshold coding rate associated with the range of coding rates (e.g., a minimum coding rate, rₘᵢₙ), and a quantity of coded bits per CCE (e.g.,

$${N}_{CCE}^{codedbits} ) .$$

The second threshold quantity of CCEs may be based on the DCI size (e.g.,

$${N}_{DCI}^{size} ) ,$$

a second threshold coding rate associated with the range of coding rates (e.g., a maximum code rate, rₘₐₓ), and the quantity of coded bits per CCE (e.g.,

$${N}_{CCE}^{codedbits} ) .$$

In some examples, the network entity 105-b may select the subset of PDCCH candidates to include one or more PDCCH candidates based at least in part on a relationship between one or more aggregation levels associated with the one or more PDCCH candidates and a nominal quantity of CCEs (e.g.,

$${N}_{nominal}^{CCE} ) .$$

The nominal quantity of CCEs may be based on a size of a payload of a DCI (e.g.,

$${N}_{DCI}^{size} ) ,$$

a nominal coding rate (e.g., rₙₒₘᵢₙₐₗ), and a quantity of coded bits per CCE (e.g.,

$${N}_{CCE}^{codedbits} ) .$$

The subset of PDCCH candidates may include one or more PDCCH candidates associated with a smallest aggregation level that is greater than or equal to the nominal quantity of CCEs (e.g.,

$$AL \geq {N}_{nominal}^{CCE} ) ,$$

one or more PDCCH candidates associated with a largest aggregation level that is less than or equal to the nominal quantity of CCES (e.g.,

$$AL \leq {N}_{nominal}^{CCE} ) ,$$

one or more PDCCH candidates associated with one or more aggregation levels that are closest to the nominal quantity of CCEs (e.g., the aggregation level with the smallest

$$\vert AL - {N}_{nominal}^{CCE} \vert ) ,$$

or any combination thereof.

In some examples, the network entity 105-b may select the subset of PDCCH candidates based on a first limit of a quantity of PDCCH candidates in the subset of PDCCH candidates (e.g., a limit for a quantity of blind decodes) and a second limit of a quantity of CCEs in the subset of PDCCH candidates (e.g., as configured by the one or more control messages at 415). The first limit, the second limit, or both may be configured by the control message received at 415 for each search space set of the set of multiple search space sets. One or more PDCCH candidates may be excluded from the subset of PDCCH candidates based on a priority associated with the subset of PDCCH candidates. The priority associated with the subset of PDCCH candidates may be based on an aggregation level for each PDCCH candidate of the subset of PDCCH candidates and based on a candidate index for each PDCCH candidate of the subset of PDCCH candidates. In some examples, the network entity 105-b may select the subset of PDCCH candidates based on the capability indication obtained at 405.

At 415, the network entity 105-b may output or transmit, and the UE 115-b may receive, one or more control messages configuring a set of multiple search space sets. Each search space set of the set of multiple search space sets may be associated with one or more DCI formats and a set of PDCCH candidates per aggregation level. In some examples, the network entity 105-b may output, and the UE 115-b may receive, control signaling that modifies the size of one or more DCI messages associated with a DCI format (e.g., modify the size of a payload of the DCI from 40 to 60 bits). In some examples, the one or more control messages may configure a first limit of a quantity of PDCCH candidates in a subset of PDCCH candidates, a second limit of a quantity of CCEs in the subset of PDCCH candidates, or both for each search space set of the set of multiple search space sets. In some examples, the one or more control messages may configure one or more parameters associated with the subset of PDCCH candidates, such as a first threshold coding rate (e.g., a minimum code rate, rₘᵢₙ), a second threshold coding rate (e.g., a maximum coding rate, rₘₐₓ), a nominal coding rate (e.g., rₙₒₘᵢₙₐₗ), or any combination thereof.

At 420, the UE 115-b may select, from the set of PDCCH candidates, a subset of PDCCH candidates based on a size of one or more DCI messages and one or more configurations associated with a range of coding rates. For example, the UE 115-b may select the subset of PDCCH candidates for each time interval of one or more time intervals (e.g., a time interval 305 as described in more detail with reference to FIG. 3). Each time interval may include a PDCCH monitoring occasion of a search space set of the set of multiple search space sets, one or more slots, a time interval comprising one or more PDCCH monitoring occasions, or a combination thereof.

In some examples, the UE 115-b may select the subset of PDCCH candidates for each DCI format of one or more DCI formats that the UE 115-b is to monitor in the one or more search space sets of the set of multiple search space sets. Additionally, or alternatively, the UE 115-b may select the subset of PDCCH candidates based on the control signaling received at 415 that modifies the size of one or more DCI messages associated with a DCI format. In some examples, the UE 115-b may select the subset of PDCCH candidates to include one or more PDCCH candidates associated with an aggregation level that is greater than or equal to a threshold quantity of CCEs (e.g., a minimum quantity of CCEs,

$${N}_{min}^{CCE} ) .$$

The threshold quantity of CCEs may be based on a DCI size (e.g.,

$${N}_{DCI}^{size} ) ,$$

a threshold coding rate associated with the range of coding rates (e.g., a maximum coding rate, rₘₐₓ), and a quantity of coded bits per CCE (e.g.,

$${N}_{CCE}^{codedbits} ) .$$

In some examples, the UE 115-b may select the subset of PDCCH candidates to include one or more PDCCH candidates associated with an aggregation level that is less than or equal to a threshold quantity of CCEs (e.g., a maximum quantity of CCEs,

$${N}_{max}^{CCE} ) .$$

The threshold quantity of CCEs may be based on a DCI size (e.g.,

$${N}_{DCI}^{size} ) ,$$

a threshold coding rate associated with the range of coding rates (e.g., a minimum coding rate, rₘᵢₙ), and a quantity of coded bits per CCE (e.g.,

$${N}_{CCE}^{codedbits} ) .$$

In some examples, the UE 115-b may select the subset of PDCCH candidates to include one or more PDCCH candidates associated with an aggregation level that is less than or equal to a first threshold quantity of CCEs (e.g., a maximum quantity of CCEs,

$${N}_{max}^{CCE} )$$

and that is greater than or equal to a second threshold quantity of CCEs (e.g., a minimum quantity of CCEs,

$${N}_{min}^{CCE} ) .$$

The first threshold quantity of CCEs may be based on a DCI size (e.g.,

$${N}_{DCI}^{size} ) ,$$

a first threshold coding rate associated with the range of coding rates (e.g., a minimum coding rate, rₘᵢₙ), and a quantity of coded bits per CCE (e.g.,

$${N}_{CCE}^{codedbits} ) .$$

The second threshold quantity of CCEs may be based on the DCI size (e.g.,

$${N}_{DCI}^{size} ) ,$$

a second threshold coding rate associated with the range of coding rates (e.g., a maximum code rate, rₘₐₓ), and the quantity of coded bits per CCE (e.g.,

$${N}_{C C E}^{codedbits} ) .$$

In some examples, the UE 115-b may select the subset of PDCCH candidates to include one or more PDCCH candidates based at least in part on a relationship between one or more aggregation levels associated with the one or more PDCCH candidates and a nominal quantity of CCEs (e.g.,

$${N}_{nominal}^{CCE} ) .$$

The nominal quantity of CCEs may be based on a size of a payload of a DCI (e.g.,

$${N}_{DCI}^{size} ) ,$$

a nominal coding rate (e.g., rₙₒₘᵢₙₐₗ), and a quantity of coded bits per CCE (e.g.,

$${N}_{C C E}^{codedbits} ) .$$

The subset of PDCCH candidates may include one or more PDCCH candidates associated with a smallest aggregation level that is greater than or equal to the nominal quantity of CCEs (e.g.,

$$A L \geq {N}_{nominal}^{CCE} ) ,$$

one or more PDCCH candidates associated with a largest aggregation level that is less than or equal to the nominal quantity of CCEs (e.g.,

$$AL \leq {N}_{nominal}^{CCE} ) ,$$

one or more PDCCH candidates associated with one or more aggregation levels that are closest to the nominal quantity of CCEs (e.g., the aggregation level with the smallest

$$\vert AL - {N}_{nominal}^{CCE} \vert ) ,$$

or any combination thereof.

In some examples, the UE 115-b may select the subset of PDCCH candidates based on a first limit of a quantity of PDCCH candidates in the subset of PDCCH candidates (e.g., a limit for a quantity of blind decodes) and a second limit of a quantity of CCEs in the subset of PDCCH candidates (e.g., as configured by the one or more control messages at 415). The first limit, the second limit, or both may be configured by the control message received at 415 for each search space set of the set of multiple search space sets. One or more PDCCH candidates may be excluded from the subset of PDCCH candidates based on a priority associated with the subset of PDCCH candidates. The priority associated with the subset of PDCCH candidates may be based on an aggregation level for each PDCCH candidate of the subset of PDCCH candidates and based on a candidate index for each PDCCH candidate of the subset of PDCCH candidates. In some examples, the UE 115-b may select the subset of PDCCH candidates based on the capability indication obtained at 405.

At 425, the UE 115-b may monitor one or more search space sets of the set of multiple search space sets based on the selected subset of PDCCH candidates. The network entity 105-b may output or transmit, and the UE 115-b may receive, one or more DCI messages in a search space set of the set of multiple search space sets based on the subset of PDCCH candidates.

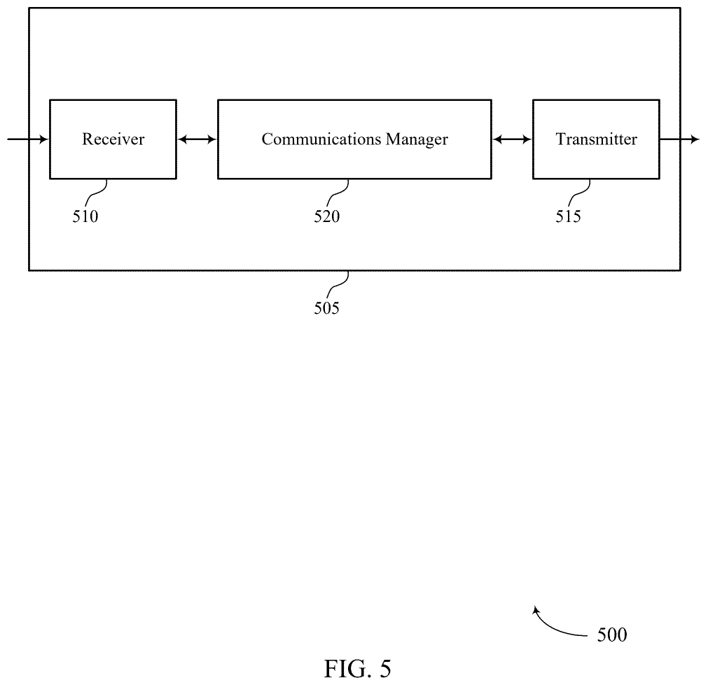

FIG. 5 shows a block diagram 500 of a device 505 that supports DCI size-dependent aggregation levels in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to DCI size-dependent aggregation levels). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to DCI size-dependent aggregation levels). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of DCI size-dependent aggregation levels as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), a graphics processing unit (GPU), a neural processing unit (NPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for receiving one or more control messages configuring a set of multiple search space sets, where each search space set of the set of multiple search space sets is associated with one or more DCI formats and a set of PDCCH candidates per aggregation level. The communications manager 520 is capable of, configured to, or operable to support a means for selecting, from the set of PDCCH candidates, a subset of PDCCH candidates based on a size of one or more DCI messages and one or more configurations associated with a range of coding rates. The communications manager 520 is capable of, configured to, or operable to support a means for monitoring one or more search space sets of the set of multiple search space sets based on the selected subset of PDCCH candidates.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, and more efficient utilization of communication resources.

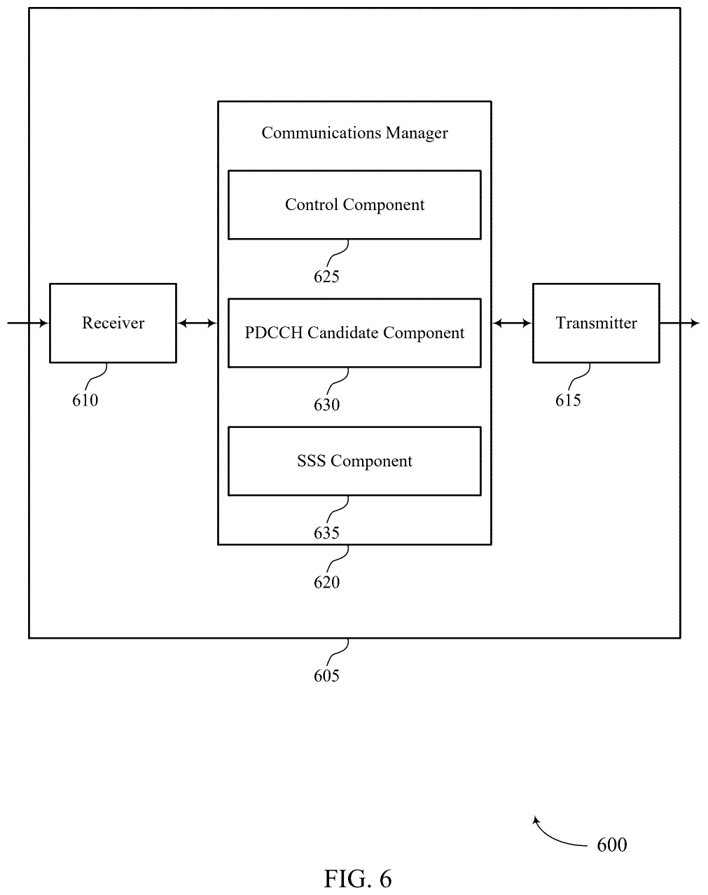

FIG. 6 shows a block diagram 600 of a device 605 that supports DCI size-dependent aggregation levels in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to DCI size-dependent aggregation levels). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to DCI size-dependent aggregation levels). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of DCI size-dependent aggregation levels as described herein. For example, the communications manager 620 may include a control component 625, a PDCCH candidate component 630, a search space set (SSS) component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The control component 625 is capable of, configured to, or operable to support a means for receiving one or more control messages configuring a set of multiple search space sets, where each search space set of the set of multiple search space sets is associated with one or more DCI formats and a set of PDCCH candidates per aggregation level. The PDCCH candidate component 630 is capable of, configured to, or operable to support a means for selecting, from the set of PDCCH candidates, a subset of PDCCH candidates based on a size of one or more DCI messages and one or more configurations associated with a range of coding rates. The SSS component 635 is capable of, configured to, or operable to support a means for monitoring one or more search space sets of the set of multiple search space sets based on the selected subset of PDCCH candidates.

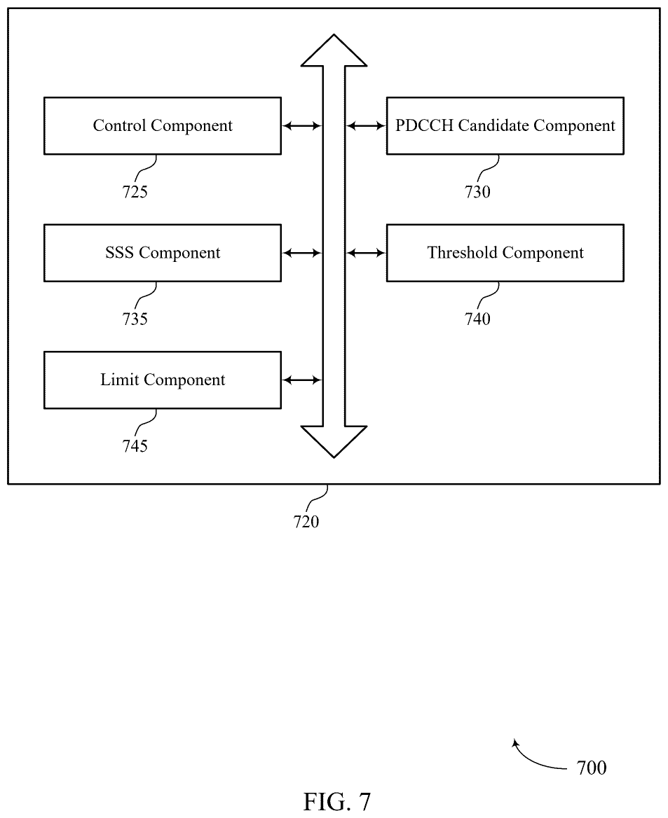

FIG. 7 shows a block diagram 700 of a communications manager 720 that supports DCI size-dependent aggregation levels in accordance with one or more aspects of the present disclosure. The communications manager 720 may be an example of aspects of a communications manager 520, a communications manager 620, or both, as described herein. The communications manager 720, or various components thereof, may be an example of means for performing various aspects of DCI size-dependent aggregation levels as described herein. For example, the communications manager 720 may include a control component 725, a PDCCH candidate component 730, an SSS component 735, a threshold component 740, a limit component 745, or any combination thereof. Each of these components, or components or subcomponents thereof (e.g., one or more processors, one or more memories), may communicate, directly or indirectly, with one another (e.g., via one or more buses).

The communications manager 720 may support wireless communications in accordance with examples as disclosed herein. The control component 725 is capable of, configured to, or operable to support a means for receiving one or more control messages configuring a set of multiple search space sets, where each search space set of the set of multiple search space sets is associated with one or more DCI formats and a set of PDCCH candidates per aggregation level. The PDCCH candidate component 730 is capable of, configured to, or operable to support a means for selecting, from the set of PDCCH candidates, a subset of PDCCH candidates based on a size of one or more DCI messages and one or more configurations associated with a range of coding rates. The SSS component 735 is capable of, configured to, or operable to support a means for monitoring one or more search space sets of the set of multiple search space sets based on the selected subset of PDCCH candidates.

In some examples, to support selecting the subset of PDCCH candidates, the PDCCH candidate component 730 is capable of, configured to, or operable to support a means for selecting the subset of PDCCH candidates for each time interval of one or more time intervals, where each time interval includes a PDCCH monitoring occasion of a search space set of the set of multiple search space sets, a slot, a time interval including one or more PDCCH monitoring occasions, or a combination thereof.

In some examples, to support selecting the subset of PDCCH candidates, the PDCCH candidate component 730 is capable of, configured to, or operable to support a means for selecting the subset of PDCCH candidates for each DCI format of one or more DCI formats that the UE is to monitor in the one or more search space sets of the set of multiple search space sets.

In some examples, the control component 725 is capable of, configured to, or operable to support a means for receiving control signaling that modifies the size of the one or more DCI messages associated with a DCI format, where selecting the subset of PDCCH candidates is based on the control signaling.

In some examples, to support selecting the subset of PDCCH candidates, the threshold component 740 is capable of, configured to, or operable to support a means for selecting the subset of PDCCH candidates to include one or more PDCCH candidates associated with an aggregation level that is greater than or equal to a threshold quantity of CCEs, where the threshold quantity of CCEs is based on a DCI size, a threshold coding rate associated with the range of coding rates, and a quantity of coded bits per CCE.

In some examples, to support selecting the subset of PDCCH candidates, the threshold component 740 is capable of, configured to, or operable to support a means for selecting the subset of PDCCH candidates to include one or more PDCCH candidates associated with an aggregation level that is less than or equal to a threshold quantity of CCEs, where the threshold quantity of CCEs is based on a DCI size, a threshold coding rate associated with the range of coding rates, and a quantity of coded bits per CCE.

In some examples, to support selecting the subset of PDCCH candidates, the threshold component 740 is capable of, configured to, or operable to support a means for selecting the subset of PDCCH candidates to include one or more PDCCH candidates associated with an aggregation level that is less than or equal to a first threshold quantity of CCEs and that is greater than or equal to a second threshold quantity of CCEs, where the first threshold quantity of CCEs is based on a DCI size, a first threshold coding rate associated with the range of coding rates, and a quantity of coded bits per CCE, and where the second threshold quantity of CCEs is based on the DCI size, a second threshold coding rate associated with the range of coding rates, and the quantity of coded bits per CCE.

In some examples, to support selecting the subset of PDCCH candidates, the PDCCH candidate component 730 is capable of, configured to, or operable to support a means for selecting the subset of PDCCH candidates to include one or more PDCCH candidates based on a relationship between one or more aggregation levels associated with the one or more PDCCH candidates and a nominal quantity of CCEs, where the nominal quantity of CCEs is based on a size of a payload of a DCI, a nominal coding rate, and a quantity of coded bits per CCE.

In some examples, the subset of PDCCH candidates includes one or more PDCCH candidates associated with a smallest aggregation level that is greater than or equal to the nominal quantity of CCEs, one or more PDCCH candidates associated with a largest aggregation level that is less than or equal to the nominal quantity of CCEs, one or more PDCCH candidates associated with one or more aggregation levels that are closest to the nominal quantity of CCEs, or any combination thereof.

In some examples, to support selecting the subset of PDCCH candidates, the limit component 745 is capable of, configured to, or operable to support a means for selecting the subset of PDCCH candidates based on a first limit to a quantity of PDCCH candidates in the subset of PDCCH candidates and a second limit of a quantity of CCEs in the subset of PDCCH candidates, where one or more PDCCH candidates are excluded from the subset of PDCCH candidates based on a priority associated with the subset of PDCCH candidates.

In some examples, the limit component 745 is capable of, configured to, or operable to support a means for receiving one or more control messages configuring the first limit of the quantity of PDCCH candidates in the subset of PDCCH candidates, the second limit of the quantity of CCEs in the subset of PDCCH candidates, or both for each search space set of the set of multiple search space sets.

In some examples, the priority associated with the subset of PDCCH candidates is based on an aggregation level for each PDCCH candidate of the subset of PDCCH candidates and based on a candidate index for each PDCCH candidate of the subset of PDCCH candidates.

In some examples, the control component 725 is capable of, configured to, or operable to support a means for receiving one or more control messages configuring one or more parameters associated with the subset of PDCCH candidates, a first threshold coding rate, a second threshold coding rate, a nominal coding rate, or any combination thereof, where selecting the subset of PDCCH candidates is based on the one or more control messages.

In some examples, the control component 725 is capable of, configured to, or operable to support a means for transmitting an indication of a capability for selecting and monitoring for the subset of PDCCH candidates, where the subset of PDCCH candidates are selected based on the capability.

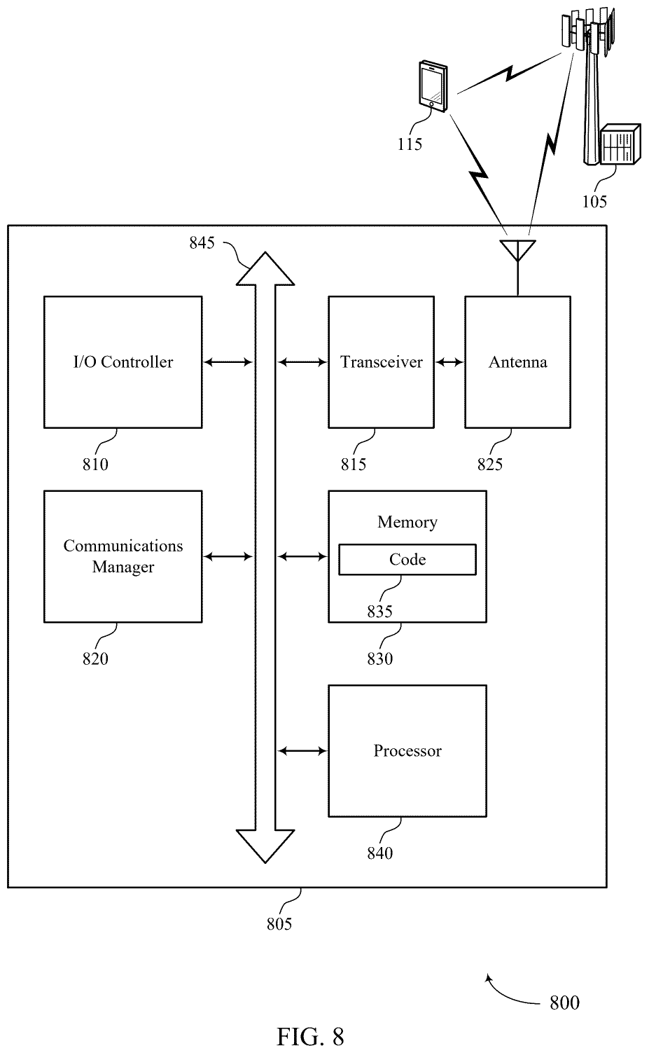

FIG. 8 shows a diagram of a system 800 including a device 805 that supports DCI size-dependent aggregation levels in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more GPUs, one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting DCI size-dependent aggregation levels). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

The communications manager 820 may support wireless communications in accordance with examples as disclosed herein. For example, the communications manager 820 is capable of, configured to, or operable to support a means for receiving one or more control messages configuring a set of multiple search space sets, where each search space set of the set of multiple search space sets is associated with one or more DCI formats and a set of PDCCH candidates per aggregation level. The communications manager 820 is capable of, configured to, or operable to support a means for selecting, from the set of PDCCH candidates, a subset of PDCCH candidates based on a size of one or more DCI messages and one or more configurations associated with a range of coding rates. The communications manager 820 is capable of, configured to, or operable to support a means for monitoring one or more search space sets of the set of multiple search space sets based on the selected subset of PDCCH candidates.

By including or configuring the communications manager 820 in accordance with examples as described herein, the device 805 may support techniques for reduced latency, improved user experience related to reduced processing, reduced power consumption, more efficient utilization of communication resources, and longer battery life.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of DCI size-dependent aggregation levels as described herein, or the at least one processor 840 and the at least one memory 830 may be otherwise configured to, individually or collectively, perform or support such operations.

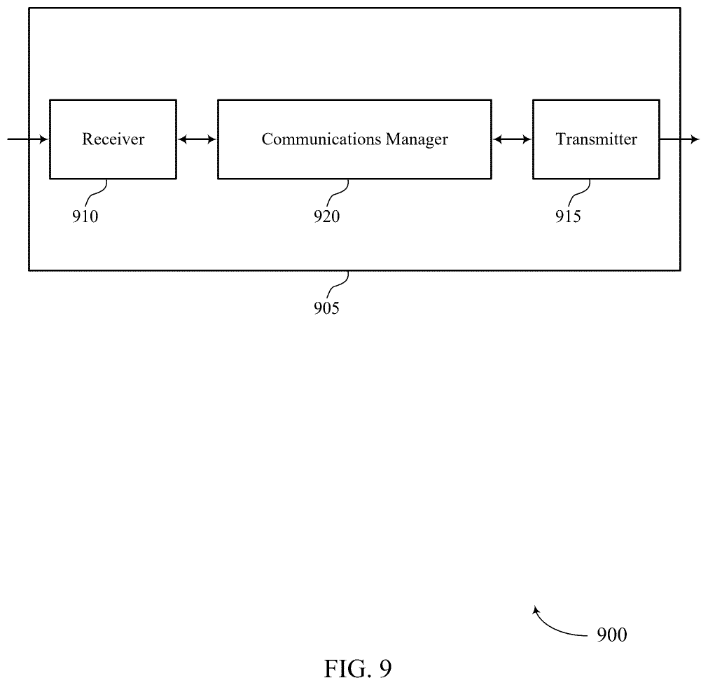

FIG. 9 shows a block diagram 900 of a device 905 that supports DCI size-dependent aggregation levels in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of DCI size-dependent aggregation levels as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, a GPU, an NPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. For example, the communications manager 920 is capable of, configured to, or operable to support a means for outputting one or more control messages configuring a set of multiple search space sets, where each search space set of the set of multiple search space sets is associated with one or more DCI formats and a set of PDCCH candidates per aggregation level. The communications manager 920 is capable of, configured to, or operable to support a means for selecting, from the set of PDCCH candidates, a subset of PDCCH candidates based on a size of one or more DCI messages and one or more configurations associated with a range of coding rates. The communications manager 920 is capable of, configured to, or operable to support a means for outputting a DCI in a search space set of the set of multiple search space sets based on the selected subset of PDCCH candidates.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, and more efficient utilization of communication resources.

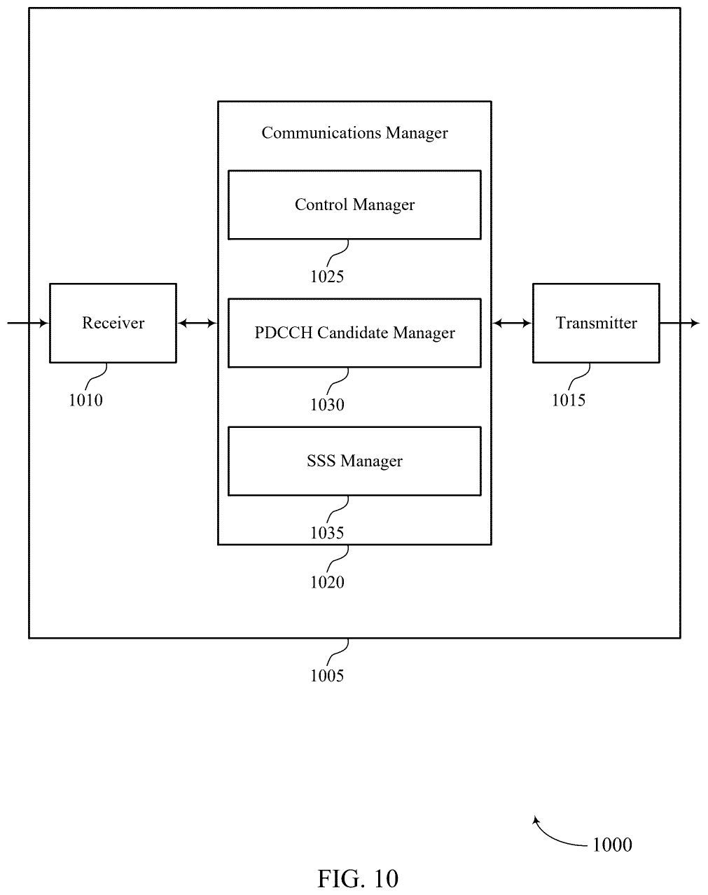

FIG. 10 shows a block diagram 1000 of a device 1005 that supports DCI size-dependent aggregation levels in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of DCI size-dependent aggregation levels as described herein. For example, the communications manager 1020 may include a control manager 1025, a PDCCH candidate manager 1030, an SSS manager 1035, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. The control manager 1025 is capable of, configured to, or operable to support a means for outputting one or more control messages configuring a set of multiple search space sets, where each search space set of the set of multiple search space sets is associated with one or more DCI formats and a set of PDCCH candidates per aggregation level. The PDCCH candidate manager 1030 is capable of, configured to, or operable to support a means for selecting, from the set of PDCCH candidates, a subset of PDCCH candidates based on a size of one or more DCI messages and one or more configurations associated with a range of coding rates. The SSS manager 1035 is capable of, configured to, or operable to support a means for outputting a DCI in a search space set of the set of multiple search space sets based on the selected subset of PDCCH candidates.

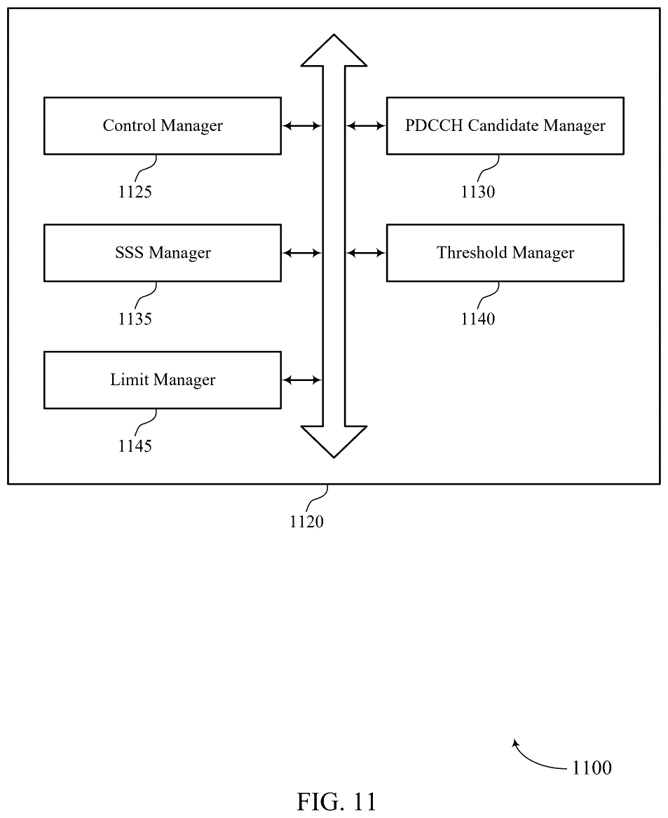

FIG. 11 shows a block diagram 1100 of a communications manager 1120 that supports DCI size-dependent aggregation levels in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of DCI size-dependent aggregation levels as described herein. For example, the communications manager 1120 may include a control manager 1125, a PDCCH candidate manager 1130, an SSS manager 1135, a threshold manager 1140, a limit manager 1145, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications in accordance with examples as disclosed herein. The control manager 1125 is capable of, configured to, or operable to support a means for outputting one or more control messages configuring a set of multiple search space sets, where each search space set of the set of multiple search space sets is associated with one or more DCI formats and a set of PDCCH candidates per aggregation level. The PDCCH candidate manager 1130 is capable of, configured to, or operable to support a means for selecting, from the set of PDCCH candidates, a subset of PDCCH candidates based on a size of one or more DCI messages and one or more configurations associated with a range of coding rates. The SSS manager 1135 is capable of, configured to, or operable to support a means for outputting a DCI in a search space set of the set of multiple search space sets based on the selected subset of PDCCH candidates.

In some examples, to support selecting the subset of PDCCH candidates, the PDCCH candidate manager 1130 is capable of, configured to, or operable to support a means for selecting the subset of PDCCH candidates for each time interval of one or more time intervals, where each time interval includes a PDCCH monitoring occasion of a search space set of the set of multiple search space sets, a slot, a time interval including one or more PDCCH monitoring occasions, or a combination thereof.

In some examples, to support selecting the subset of PDCCH candidates, the PDCCH candidate manager 1130 is capable of, configured to, or operable to support a means for selecting the subset of PDCCH candidates for each DCI format of the one or more DCI formats for the one or more search space sets of the set of multiple search space sets.

In some examples, to support selecting the subset of PDCCH candidates, the control manager 1125 is capable of, configured to, or operable to support a means for outputting control signaling that modifies the size of the one or more DCI messages associated with a DCI format, where selecting the subset of PDCCH candidates is based on the control signaling.

In some examples, to support selecting the subset of PDCCH candidates, the threshold manager 1140 is capable of, configured to, or operable to support a means for selecting the subset of PDCCH candidates to include one or more PDCCH candidates associated with an aggregation level that is greater than or equal to a threshold quantity of CCEs, where the threshold quantity of CCEs is based on a DCI size, a threshold coding rate associated with the range of coding rates, and a quantity of coded bits per CCE.

In some examples, to support selecting the subset of PDCCH candidates, the threshold manager 1140 is capable of, configured to, or operable to support a means for selecting the subset of PDCCH candidates to include one or more PDCCH candidates associated with an aggregation level that is less than or equal to a threshold quantity of CCEs, where the threshold quantity of CCEs is based on a DCI size, a threshold coding rate associated with the range of coding rates, and a quantity of coded bits per CCE.

In some examples, to support selecting the subset of PDCCH candidates, the threshold manager 1140 is capable of, configured to, or operable to support a means for selecting the subset of PDCCH candidates to include one or more PDCCH candidates associated with an aggregation level that is less than or equal to a first threshold quantity of CCEs and that is greater than or equal to a second threshold quantity of CCEs, where the first threshold quantity of CCEs is based on a DCI size, a first threshold coding rate associated with the range of coding rates, and a quantity of coded bits per CCE, and where the second threshold quantity of CCEs is based on the DCI size, a second threshold coding rate associated with the range of coding rates, and the quantity of coded bits per CCE.

In some examples, to support selecting the subset of PDCCH candidates, the PDCCH candidate manager 1130 is capable of, configured to, or operable to support a means for selecting the subset of PDCCH candidates to include one or more PDCCH candidates based on a relationship between one or more aggregation levels associated with the one or more PDCCH candidates and a nominal quantity of CCEs, where the nominal quantity of CCEs is based on a size of a payload of a DCI, a nominal coding rate, and a quantity of coded bits per CCE.

In some examples, the subset of PDCCH candidates includes one or more PDCCH candidates associated with a smallest aggregation level that is greater than or equal to the nominal quantity of CCEs, one or more PDCCH candidates associated with a largest aggregation level that is less than or equal to the nominal quantity of CCEs, one or more PDCCH candidates associated with one or more aggregation levels that are closest to the nominal quantity of CCEs, or any combination thereof.

In some examples, to support selecting the subset of PDCCH candidates, the limit manager 1145 is capable of, configured to, or operable to support a means for selecting the subset of PDCCH candidates based on a first limit of a quantity of PDCCH candidates in the subset of PDCCH candidates and a second limit of a quantity of CCEs in the subset of PDCCH candidates, where one or more PDCCH candidates are excluded from the subset of PDCCH candidates based on a priority associated with the subset of PDCCH candidates.

In some examples, the limit manager 1145 is capable of, configured to, or operable to support a means for outputting one or more control messages configuring the first limit of the quantity of PDCCH candidates in the subset of PDCCH candidates, the second limit of the quantity of CCEs in the subset of PDCCH candidates, or both for each search space set of the set of multiple search space sets.

In some examples, the priority associated with the subset of PDCCH candidates is based on an aggregation level for each PDCCH candidate of the subset of PDCCH candidates and based on a candidate index for each PDCCH candidate of the subset of PDCCH candidates.

In some examples, the control manager 1125 is capable of, configured to, or operable to support a means for outputting one or more control messages configuring one or more parameters associated with the subset of PDCCH candidates, a first threshold coding rate, a second threshold coding rate, a nominal coding rate, or any combination thereof, where selecting the subset of PDCCH candidates is based on the one or more control messages.

In some examples, the control manager 1125 is capable of, configured to, or operable to support a means for obtaining an indication of a capability of a UE for selecting and monitoring for the subset of PDCCH candidates, where the subset of PDCCH candidates are selected based on the capability of the UE.

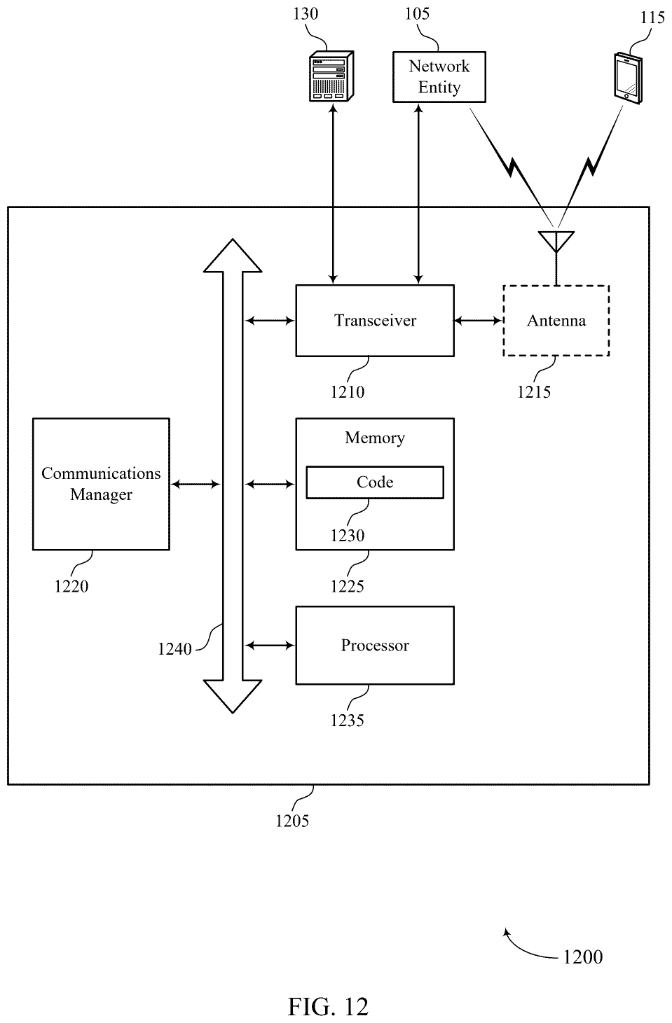

FIG. 12 shows a diagram of a system 1200 including a device 1205 that supports DCI size-dependent aggregation levels in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more GPUs, one or more NPUs (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting DCI size-dependent aggregation levels). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

The communications manager 1220 may support wireless communications in accordance with examples as disclosed herein. For example, the communications manager 1220 is capable of, configured to, or operable to support a means for outputting one or more control messages configuring a set of multiple search space sets, where each search space set of the set of multiple search space sets is associated with one or more DCI formats and a set of PDCCH candidates per aggregation level. The communications manager 1220 is capable of, configured to, or operable to support a means for selecting, from the set of PDCCH candidates, a subset of PDCCH candidates based on a size of one or more DCI messages and one or more configurations associated with a range of coding rates. The communications manager 1220 is capable of, configured to, or operable to support a means for outputting a DCI in a search space set of the set of multiple search space sets based on the selected subset of PDCCH candidates.

By including or configuring the communications manager 1220 in accordance with examples as described herein, the device 1205 may support techniques for reduced latency, improved user experience related to reduced processing, reduced power consumption, more efficient utilization of communication resources, and longer battery life.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of DCI size-dependent aggregation levels as described herein, or the at least one processor 1235 and the at least one memory 1225 may be otherwise configured to, individually or collectively, perform or support such operations.

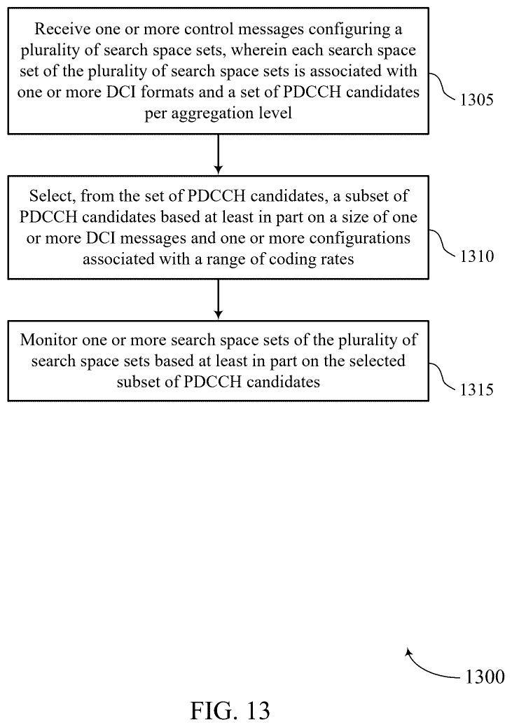

FIG. 13 shows a flowchart illustrating a method 1300 that supports DCI size-dependent aggregation levels in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving one or more control messages configuring a set of multiple search space sets, where each search space set of the set of multiple search space sets is associated with one or more DCI formats and a set of PDCCH candidates per aggregation level. The operations of 1305 may be performed in accordance with examples as disclosed herein. In some examples, aspects of the operations of 1305 may be performed by a control component 725 as described with reference to FIG. 7.

At 1310, the method may include selecting, from the set of PDCCH candidates, a subset of PDCCH candidates based on a size of one or more DCI messages and one or more configurations associated with a range of coding rates. The operations of 1310 may be performed in accordance with examples as disclosed herein. In some examples, aspects of the operations of 1310 may be performed by a PDCCH candidate component 730 as described with reference to FIG. 7.

At 1315, the method may include monitoring one or more search space sets of the set of multiple search space sets based on the selected subset of PDCCH candidates. The operations of 1315 may be performed in accordance with examples as disclosed herein. In some examples, aspects of the operations of 1315 may be performed by an SSS component 735 as described with reference to FIG. 7.

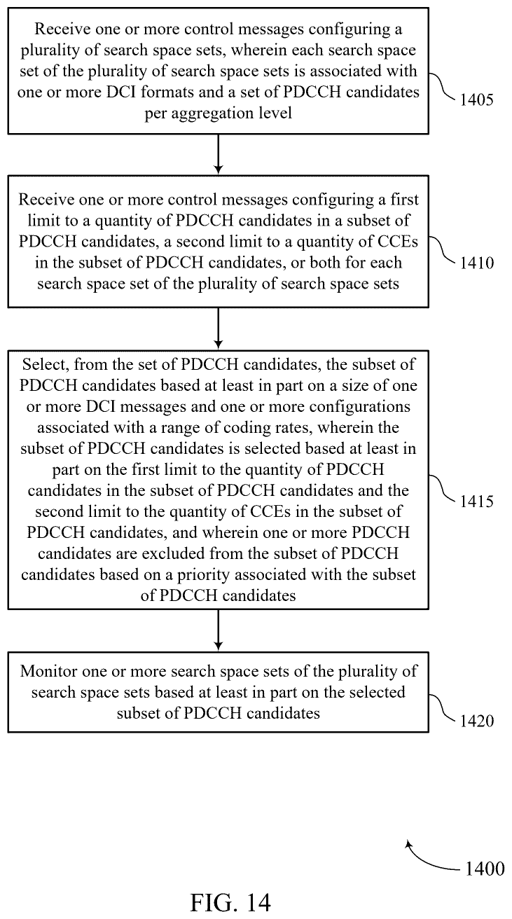

FIG. 14 shows a flowchart illustrating a method 1400 that supports DCI size-dependent aggregation levels in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving one or more control messages configuring a set of multiple search space sets, where each search space set of the set of multiple search space sets is associated with one or more DCI formats and a set of PDCCH candidates per aggregation level. The operations of 1405 may be performed in accordance with examples as disclosed herein. In some examples, aspects of the operations of 1405 may be performed by a control component 725 as described with reference to FIG. 7.

At 1410, the method may include receiving one or more control messages configuring the first limit of the quantity of PDCCH candidates in the subset of PDCCH candidates, the second limit of the quantity of CCEs in the subset of PDCCH candidates, or both for each search space set of the set of multiple search space sets. The operations of 1410 may be performed in accordance with examples as disclosed herein. In some examples, aspects of the operations of 1410 may be performed by a limit component 745 as described with reference to FIG. 7.

At 1415, the method may include selecting, from the set of PDCCH candidates, a subset of PDCCH candidates based on a size of one or more DCI messages and one or more configurations associated with a range of coding rates, where the subset of PDCCH candidates is selected based on the first limit to a quantity of PDCCH candidates in the subset of PDCCH candidates and the second limit of a quantity of CCEs in the subset of PDCCH candidates. In some examples, one or more PDCCH candidates are excluded from the subset of PDCCH candidates based on a priority associated with the subset of PDCCH candidates. The operations of 1415 may be performed in accordance with examples as disclosed herein. In some examples, aspects of the operations of 1415 may be performed by a PDCCH candidate component 730 and/or a limit component 745 as described with reference to FIG. 7.

At 1420, the method may include monitoring one or more search space sets of the set of multiple search space sets based on the selected subset of PDCCH candidates. The operations of 1420 may be performed in accordance with examples as disclosed herein. In some examples, aspects of the operations of 1420 may be performed by an SSS component 735 as described with reference to FIG. 7.

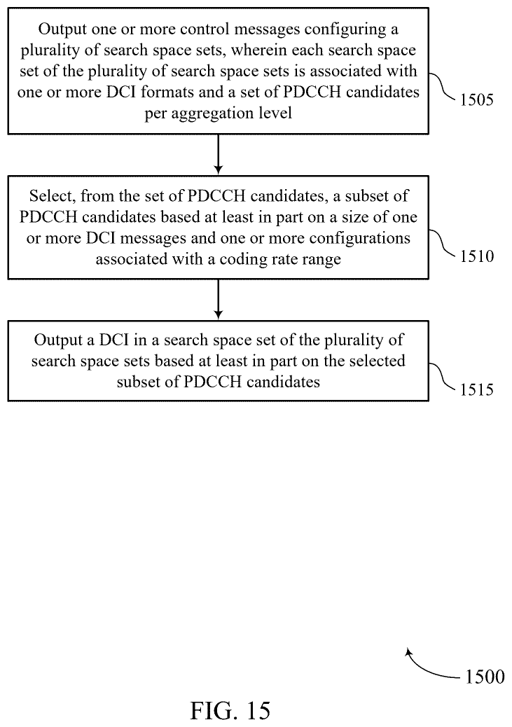

FIG. 15 shows a flowchart illustrating a method 1500 that supports DCI size-dependent aggregation levels in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include outputting one or more control messages configuring a set of multiple search space sets, where each search space set of the set of multiple search space sets is associated with one or more DCI formats and a set of PDCCH candidates per aggregation level. The operations of 1505 may be performed in accordance with examples as disclosed herein. In some examples, aspects of the operations of 1505 may be performed by a control manager 1125 as described with reference to FIG. 11.

At 1510, the method may include selecting, from the set of PDCCH candidates, a subset of PDCCH candidates based on a size of one or more DCI messages and one or more configurations associated with a range of coding rates. The operations of 1510 may be performed in accordance with examples as disclosed herein. In some examples, aspects of the operations of 1510 may be performed by a PDCCH candidate manager 1130 as described with reference to FIG. 11.

At 1515, the method may include outputting a DCI in a search space set of the set of multiple search space sets based on the selected subset of PDCCH candidates. The operations of 1515 may be performed in accordance with examples as disclosed herein. In some examples, aspects of the operations of 1515 may be performed by an SSS manager 1135 as described with reference to FIG. 11.

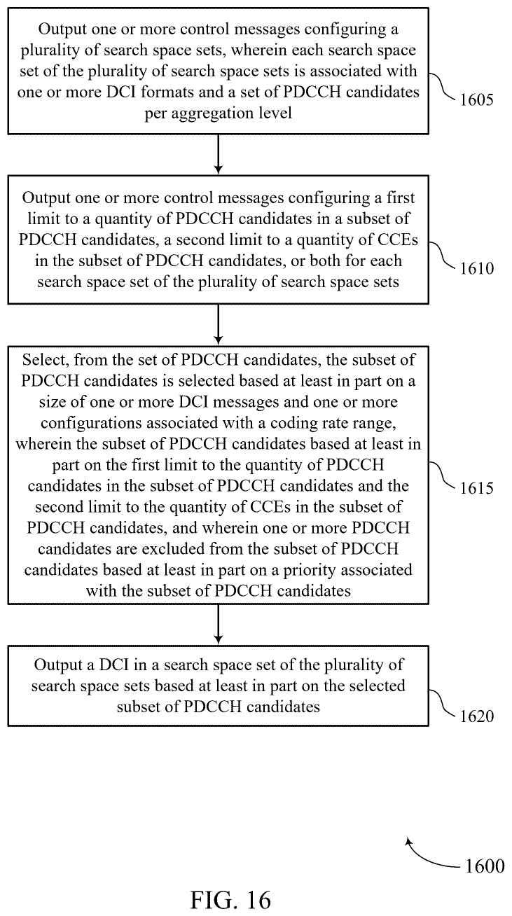

FIG. 16 shows a flowchart illustrating a method 1600 that supports DCI size-dependent aggregation levels in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting one or more control messages configuring a set of multiple search space sets, where each search space set of the set of multiple search space sets is associated with one or more DCI formats and a set of PDCCH candidates per aggregation level. The operations of 1605 may be performed in accordance with examples as disclosed herein. In some examples, aspects of the operations of 1605 may be performed by a control manager 1125 as described with reference to FIG. 11.

At 1610, the method may include outputting one or more control messages configuring the first limit of the quantity of PDCCH candidates in the subset of PDCCH candidates, the second limit of the quantity of CCEs in the subset of PDCCH candidates, or both for each search space set of the set of multiple search space sets. The operations of 1610 may be performed in accordance with examples as disclosed herein. In some examples, aspects of the operations of 1610 may be performed by a limit manager 1145 as described with reference to FIG. 11.

At 1615, the method may include selecting, from the set of PDCCH candidates, a subset of PDCCH candidates based on a size of one or more DCI messages and one or more configurations associated with a range of coding rates, where the subset of PDCCH candidates may be selected based on a first limit of a quantity of PDCCH candidates in the subset of PDCCH candidates and a second limit of a quantity of CCEs in the subset of PDCCH candidates. In some examples, one or more PDCCH candidates may be excluded from the subset of PDCCH candidates based on a priority associated with the subset of PDCCH candidates. The operations of 1615 may be performed in accordance with examples as disclosed herein. In some examples, aspects of the operations of 1615 may be performed by a PDCCH candidate manager 1130 and/or a limit manager 1145 as described with reference to FIG. 11.

At 1620, the method may include outputting a DCI in a search space set of the set of multiple search space sets based on the selected subset of PDCCH candidates. The operations of 1620 may be performed in accordance with examples as disclosed herein. In some examples, aspects of the operations of 1620 may be performed by an SSS manager 1135 as described with reference to FIG. 11.

The following provides an overview of aspects of the present disclosure:

Aspect 1: A method for wireless communications at a UE, comprising: receiving one or more control messages configuring a plurality of search space sets, wherein each search space set of the plurality of search space sets is associated with one or more DCI formats and a set of PDCCH candidates per aggregation level; selecting, from the set of PDCCH candidates, a subset of PDCCH candidates based at least in part on a size of one or more DCI messages and one or more configurations associated with a range of coding rates; and monitoring one or more search space sets of the plurality of search space sets based at least in part on the selected subset of PDCCH candidates.

Aspect 2: The method of aspect 1, wherein selecting the subset of PDCCH candidates comprises: selecting the subset of PDCCH candidates for each time interval of one or more time intervals, wherein each time interval comprises a PDCCH monitoring occasion of a search space set of the plurality of search space sets, a slot, a time interval comprising one or more PDCCH monitoring occasions, or a combination thereof.

Aspect 3: The method of any of aspects 1 through 2, wherein selecting the subset of PDCCH candidates comprises: selecting the subset of PDCCH candidates for each DCI format of one or more DCI formats that the UE is to monitor in the one or more search space sets of the plurality of search space sets.

Aspect 4: The method of any of aspects 1 through 3, further comprising: receiving control signaling that modifies the size of the one or more DCI messages associated with a DCI format, wherein selecting the subset of PDCCH candidates is based at least in part on the control signaling.

Aspect 5: The method of any of aspects 1 through 4, wherein selecting the subset of PDCCH candidates comprises: selecting the subset of PDCCH candidates to include one or more PDCCH candidates associated with an aggregation level that is greater than or equal to a threshold quantity of control channel elements (CCEs), wherein the threshold quantity of CCEs is based at least in part on a DCI size, a threshold coding rate associated with the range of coding rates, and a quantity of coded bits per CCE.

Aspect 6: The method of any of aspects 1 through 5, wherein selecting the subset of PDCCH candidates comprises: selecting the subset of PDCCH candidates to include one or more PDCCH candidates associated with an aggregation level that is less than or equal to a threshold quantity of control channel elements (CCEs), wherein the threshold quantity of CCEs is based at least in part on a DCI size, a threshold coding rate associated with the range of coding rates, and a quantity of coded bits per CCE.

Aspect 7: The method of any of aspects 1 through 6, wherein selecting the subset of PDCCH candidates comprises: selecting the subset of PDCCH candidates to include one or more PDCCH candidates associated with an aggregation level that is less than or equal to a first threshold quantity of control channel elements (CCEs) and that is greater than or equal to a second threshold quantity of CCEs, wherein the first threshold quantity of CCEs is based at least in part on a DCI size, a first threshold coding rate associated with the range of coding rates, and a quantity of coded bits per CCE, and wherein the second threshold quantity of CCEs is based at least in part on the DCI size, a second threshold coding rate associated with the range of coding rates, and the quantity of coded bits per CCE.

Aspect 8: The method of any of aspects 1 through 7, wherein selecting the subset of PDCCH candidates comprises: selecting the subset of PDCCH candidates to include one or more PDCCH candidates based at least in part on a relationship between one or more aggregation levels associated with the one or more PDCCH candidates and a nominal quantity of control channel elements (CCEs), wherein the nominal quantity of CCEs is based at least in part on a size of a payload of a DCI, a nominal coding rate, and a quantity of coded bits per CCE.

Aspect 9: The method of aspect 8, wherein the subset of PDCCH candidates includes one or more PDCCH candidates associated with a smallest aggregation level that is greater than or equal to the nominal quantity of CCEs, one or more PDCCH candidates associated with a largest aggregation level that is less than or equal to the nominal quantity of CCEs, one or more PDCCH candidates associated with one or more aggregation levels that are closest to the nominal quantity of CCEs, or any combination thereof.

Aspect 10: The method of any of aspects 1 through 9, wherein selecting the subset of PDCCH candidates comprises: selecting the subset of PDCCH candidates based at least in part on a first limit to a quantity of PDCCH candidates in the subset of PDCCH candidates and a second limit to a quantity of control channel elements (CCEs) in the subset of PDCCH candidates, wherein one or more PDCCH candidates are excluded from the subset of PDCCH candidates based at least in part on a priority associated with the subset of PDCCH candidates.

Aspect 11: The method of claim 10, further comprising: receiving one or more control messages configuring the first limit to the quantity of PDCCH candidates in the subset of PDCCH candidates, the second limit to the quantity of CCEs in the subset of PDCCH candidates, or both for each search space set of the plurality of search space sets.

Aspect 12: The method of claim 10, wherein the priority associated with the subset of PDCCH candidates is based at least in part on an aggregation level for each PDCCH candidate of the subset of PDCCH candidates and based at least in part on a candidate index for each PDCCH candidate of the subset of PDCCH candidates.

Aspect 13: The method of any of aspects 1 through 12, further comprising: receiving one or more control messages configuring one or more parameters associated with the subset of PDCCH candidates, a first threshold coding rate, a second threshold coding rate, a nominal coding rate, or any combination thereof, wherein selecting the subset of PDCCH candidates is based at least in part on the one or more control messages.

Aspect 14: The method of any of aspects 1 through 13, further comprising: transmitting an indication of a capability for selecting and monitoring for the subset of PDCCH candidates, wherein the subset of PDCCH candidates are selected based at least in part on the capability.

Aspect 15: A method for wireless communications at a network entity, comprising: outputting one or more control messages configuring a plurality of search space sets, wherein each search space set of the plurality of search space sets is associated with one or more DCI formats and a set of PDCCH candidates per aggregation level; selecting, from the set of PDCCH candidates, a subset of PDCCH candidates based at least in part on a size of one or more DCI messages and one or more configurations associated with a coding rate range; and outputting a DCI in a search space set of the plurality of search space sets based at least in part on the selected subset of PDCCH candidates.

Aspect 16: The method of aspect 15, wherein selecting the subset of PDCCH candidates comprises: selecting the subset of PDCCH candidates for each time interval of one or more time intervals, wherein each time interval comprises a PDCCH monitoring occasion of a search space set of the plurality of search space sets, a slot, a time interval comprising one or more PDCCH monitoring occasions, or a combination thereof.

Aspect 17: The method of any of aspects 15 through 16, wherein selecting the subset of PDCCH candidates comprises: selecting the subset of PDCCH candidates for each DCI format of the one or more DCI formats for the one or more search space sets of the plurality of search space sets.

Aspect 18: The method of any of aspects 15 through 17, wherein selecting the subset of PDCCH candidates comprises: outputting control signaling that modifies the size of the one or more DCI messages associated with a DCI format, wherein selecting the subset of PDCCH candidates is based at least in part on the control signaling.

Aspect 19: The method of any of aspects 15 through 18, wherein selecting the subset of PDCCH candidates comprises: selecting the subset of PDCCH candidates to include one or more PDCCH candidates associated with an aggregation level that is greater than or equal to a threshold quantity of control channel elements (CCEs), wherein the threshold quantity of CCEs is based at least in part on a DCI size, a threshold coding rate associated with the range of coding rates, and a quantity of coded bits per CCE.

Aspect 20: The method of any of aspects 15 through 19, wherein selecting the subset of PDCCH candidates comprises: selecting the subset of PDCCH candidates to include one or more PDCCH candidates associated with an aggregation level that is less than or equal to a threshold quantity of control channel elements (CCEs), wherein the threshold quantity of CCEs is based at least in part on a DCI size, a threshold coding rate associated with the range of coding rates, and a quantity of coded bits per CCE.

Aspect 21: The method of any of aspects 15 through 20, wherein selecting the subset of PDCCH candidates comprises: selecting the subset of PDCCH candidates to include one or more PDCCH candidates associated with an aggregation level that is less than or equal to a first threshold quantity of control channel elements (CCEs) and that is greater than or equal to a second threshold quantity of CCEs, wherein the first threshold quantity of CCEs is based at least in part on a DCI size, a first threshold coding rate associated with the range of coding rates, and a quantity of coded bits per CCE, and wherein the second threshold quantity of CCEs is based at least in part on the DCI size, a second threshold coding rate associated with the range of coding rates, and the quantity of coded bits per CCE.

Aspect 22: The method of any of aspects 15 through 21, wherein selecting the subset of PDCCH candidates comprises: selecting the subset of PDCCH candidates to include one or more PDCCH candidates based at least in part on a relationship between one or more aggregation levels associated with the one or more PDCCH candidates and a nominal quantity of control channel elements (CCEs), wherein the nominal quantity of CCEs is based at least in part on a size of a payload of a DCI, a nominal coding rate, and a quantity of coded bits per CCE.

Aspect 23: The method of aspect 22, wherein the subset of PDCCH candidates includes one or more PDCCH candidates associated with a smallest aggregation level that is greater than or equal to the nominal quantity of CCEs, one or more PDCCH candidates associated with a largest aggregation level that is less than or equal to the nominal quantity of CCEs, one or more PDCCH candidates associated with one or more aggregation levels that are closest to the nominal quantity of CCEs, or any combination thereof.

Aspect 24: The method of any of aspects 15 through 23, wherein selecting the subset of PDCCH candidates comprises: selecting the subset of PDCCH candidates based at least in part on a first limit to a quantity of PDCCH candidates in the subset of PDCCH candidates and a second limit to a quantity of control channel elements (CCEs) in the subset of PDCCH candidates, wherein one or more PDCCH candidates are excluded from the subset of PDCCH candidates based at least in part on a priority associated with the subset of PDCCH candidates.

Aspect 25: The method of aspect 24, further comprising: outputting one or more control messages configuring the first limit to the quantity of PDCCH candidates in the subset of PDCCH candidates, the second limit to the quantity of CCEs in the subset of PDCCH candidates, or both for each search space set of the plurality of search space sets.

Aspect 26: The method of any of aspects 24 through 25, wherein the priority associated with the subset of PDCCH candidates is based at least in part on an aggregation level for each PDCCH candidate of the subset of PDCCH candidates and based at least in part on a candidate index for each PDCCH candidate of the subset of PDCCH candidates.

Aspect 27: The method of any of aspects 15 through 26, further comprising: outputting one or more control messages configuring one or more parameters associated with the subset of PDCCH candidates, a first threshold coding rate, a second threshold coding rate, a nominal coding rate, or any combination thereof, wherein selecting the subset of PDCCH candidates is based at least in part on the one or more control messages.

Aspect 28: The method of any of aspects 15 through 27, further comprising: obtaining an indication of a capability of a UE for selecting and monitoring for the subset of PDCCH candidates, wherein the subset of PDCCH candidates are selected based at least in part on the capability of the UE.

Aspect 29: A UE for wireless communications, comprising one or more memories storing processor-executable code, and one or more processors coupled with (e.g., operatively, communicatively, functionally, electronically, or electrically) the one or more memories. The one or more processors may be individually or collectively operable to execute the code (e.g., directly, indirectly, after pre-processing, without pre-processing) to cause the UE to perform a method of any of aspects 1 through 14.

Aspect 30: A UE for wireless communications, comprising at least one means for performing a method of any of aspects 1 through 14.

Aspect 31: A non-transitory computer-readable medium storing code for wireless communications, the code comprising instructions executable by one or more processors to perform a method of any of aspects 1 through 14.

Aspect 32: A network entity for wireless communications, comprising one or more memories storing processor-executable code, and one or more processors coupled with the one or more memories and individually or collectively operable to execute the code to cause the network entity to perform a method of any of aspects 15 through 28.

Aspect 33: A network entity for wireless communications, comprising at least one means for performing a method of any of aspects 15 through 28.

Aspect 34: A non-transitory computer-readable medium storing code for wireless communications, the code comprising instructions executable by one or more processors (e.g., directly, indirectly, after pre-processing, without pre-processing) to perform a method of any of aspects 15 through 28.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive one or more control messages configuring a plurality of search space sets, wherein each search space set of the plurality of search space sets is associated with one or more downlink control information (DCI) formats and a set of physical downlink control channel (PDCCH) candidates per aggregation level;
select, from the set of PDCCH candidates, a subset of PDCCH candidates based at least in part on a size of one or more DCI messages and one or more configurations associated with a range of coding rates; and
monitor one or more search space sets of the plurality of search space sets based at least in part on the selected subset of PDCCH candidates.

2. The UE of claim 1, wherein, to select the subset of PDCCH candidates, the one or more processors are individually or collectively operable to execute the code to cause the UE to:
select the subset of PDCCH candidates for each time interval of one or more time intervals, wherein each time interval comprises a PDCCH monitoring occasion of a search space set of the plurality of search space sets, a slot, a time interval comprising one or more PDCCH monitoring occasions, or a combination thereof.

3. The UE of claim 1, wherein, to select the subset of PDCCH candidates, the one or more processors are individually or collectively operable to execute the code to cause the UE to:
select the subset of PDCCH candidates for each DCI format of one or more DCI formats that the UE is to monitor in the one or more search space sets of the plurality of search space sets.

4. The UE of claim 1, wherein the one or more processors are individually or collectively further operable to execute the code to cause the UE to:
receive control signaling that modifies the size of the one or more DCI messages associated with a DCI format, wherein selecting the subset of PDCCH candidates is based at least in part on the control signaling.

5. The UE of claim 1, wherein, to select the subset of PDCCH candidates, the one or more processors are individually or collectively operable to execute the code to cause the UE to:
select the subset of PDCCH candidates to include one or more PDCCH candidates associated with an aggregation level that is greater than or equal to a threshold quantity of control channel elements (CCEs), wherein the threshold quantity of CCEs is based at least in part on a DCI size, a threshold coding rate associated with the range of coding rates, and a quantity of coded bits per CCE.

6. The UE of claim 1, wherein, to select the subset of PDCCH candidates, the one or more processors are individually or collectively operable to execute the code to cause the UE to:
select the subset of PDCCH candidates to include one or more PDCCH candidates associated with an aggregation level that is less than or equal to a threshold quantity of control channel elements (CCEs), wherein the threshold quantity of CCEs is based at least in part on a DCI size, a threshold coding rate associated with the range of coding rates, and a quantity of coded bits per CCE.

7. The UE of claim 1, wherein, to select the subset of PDCCH candidates, the one or more processors are individually or collectively operable to execute the code to cause the UE to:
select the subset of PDCCH candidates to include one or more PDCCH candidates associated with an aggregation level that is less than or equal to a first threshold quantity of control channel elements (CCEs) and that is greater than or equal to a second threshold quantity of CCEs, wherein the first threshold quantity of CCEs is based at least in part on a DCI size, a first threshold coding rate associated with the range of coding rates, and a quantity of coded bits per CCE, and wherein the second threshold quantity of CCEs is based at least in part on the DCI size, a second threshold coding rate associated with the range of coding rates, and the quantity of coded bits per CCE.

8. The UE of claim 1, wherein, to select the subset of PDCCH candidates, the one or more processors are individually or collectively operable to execute the code to cause the UE to:
select the subset of PDCCH candidates to include one or more PDCCH candidates based at least in part on a relationship between one or more aggregation levels associated with the one or more PDCCH candidates and a nominal quantity of control channel elements (CCEs), wherein the nominal quantity of CCEs is based at least in part on a size of a payload of a DCI, a nominal coding rate, and a quantity of coded bits per CCE.

9. The UE of claim 8, wherein the subset of PDCCH candidates includes one or more PDCCH candidates associated with a smallest aggregation level that is greater than or equal to the nominal quantity of CCEs, one or more PDCCH candidates associated with a largest aggregation level that is less than or equal to the nominal quantity of CCEs, one or more PDCCH candidates associated with one or more aggregation levels that are closest to the nominal quantity of CCEs, or any combination thereof.

10. The UE of claim 1, wherein, to select the subset of PDCCH candidates, the one or more processors are individually or collectively operable to execute the code to cause the UE to:
select the subset of PDCCH candidates based at least in part on a first limit of a quantity of PDCCH candidates in the subset of PDCCH candidates and a second limit of a quantity of control channel elements (CCEs) in the subset of PDCCH candidates, wherein one or more PDCCH candidates are excluded from the subset of PDCCH candidates based at least in part on a priority associated with the subset of PDCCH candidates.

11. The UE of claim 10, wherein the one or more processors are individually or collectively further operable to execute the code to cause the UE to:
receive one or more control messages configuring the first limit of the quantity of PDCCH candidates in the subset of PDCCH candidates, the second limit of the quantity of CCEs in the subset of PDCCH candidates, or both for each search space set of the plurality of search space sets.

12. The UE of claim 10, wherein the priority associated with the subset of PDCCH candidates is based at least in part on an aggregation level for each PDCCH candidate of the subset of PDCCH candidates and based at least in part on a candidate index for each PDCCH candidate of the subset of PDCCH candidates.

13. The UE of claim 1, wherein the one or more processors are individually or collectively further operable to execute the code to cause the UE to:
receive one or more control messages configuring one or more parameters associated with the subset of PDCCH candidates, a first threshold coding rate, a second threshold coding rate, a nominal coding rate, or any combination thereof, wherein selecting the subset of PDCCH candidates is based at least in part on the one or more control messages.

14. The UE of claim 1, wherein the one or more processors are individually or collectively further operable to execute the code to cause the UE to:
transmit an indication of a capability for selecting and monitoring for the subset of PDCCH candidates, wherein the subset of PDCCH candidates are selected based at least in part on the capability.

15. A network entity, comprising:
one or more memories storing processor-executable code; and
one or more processors coupled with the one or more memories and individually or collectively operable to execute the code to cause the network entity to:
output one or more control messages configuring a plurality of search space sets, wherein each search space set of the plurality of search space sets is associated with one or more downlink control information (DCI) formats and a set of physical downlink control channel (PDCCH) candidates per aggregation level;
select, from the set of PDCCH candidates, a subset of PDCCH candidates based at least in part on a size of one or more DCI messages and one or more configurations associated with a range of coding rates; and
output a DCI in a search space set of the plurality of search space sets based at least in part on the selected subset of PDCCH candidates.

16. The network entity of claim 15, wherein, to select the subset of PDCCH candidates, the one or more processors are individually or collectively operable to execute the code to cause the network entity to:
select the subset of PDCCH candidates for each time interval of one or more time intervals, wherein each time interval comprises a PDCCH monitoring occasion of a search space set of the plurality of search space sets, a slot, a time interval comprising one or more PDCCH monitoring occasions, or a combination thereof.

17. The network entity of claim 15, wherein, to select the subset of PDCCH candidates, the one or more processors are individually or collectively operable to execute the code to cause the network entity to:
select the subset of PDCCH candidates for each DCI format of the one or more DCI formats for one or more search space sets of the plurality of search space sets.

18. The network entity of claim 15, wherein, to select the subset of PDCCH candidates, the one or more processors are individually or collectively operable to execute the code to cause the network entity to:
output control signaling that modifies the size of the one or more DCI messages associated with a DCI format, wherein selecting the subset of PDCCH candidates is based at least in part on the control signaling.

19. The network entity of claim 15, wherein, to select the subset of PDCCH candidates, the one or more processors are individually or collectively operable to execute the code to cause the network entity to:
select the subset of PDCCH candidates to include one or more PDCCH candidates associated with an aggregation level that is greater than or equal to a threshold quantity of control channel elements (CCEs), wherein the threshold quantity of CCEs is based at least in part on a DCI size, a threshold coding rate associated with the range of coding rates, and a quantity of coded bits per CCE.

20. The network entity of claim 15, wherein, to select the subset of PDCCH candidates, the one or more processors are individually or collectively operable to execute the code to cause the network entity to:
select the subset of PDCCH candidates to include one or more PDCCH candidates associated with an aggregation level that is less than or equal to a threshold quantity of control channel elements (CCEs), wherein the threshold quantity of CCEs is based at least in part on a DCI size, a threshold coding rate associated with the range of coding rates, and a quantity of coded bits per CCE.

21. The network entity of claim 15, wherein, to select the subset of PDCCH candidates, the one or more processors are individually or collectively operable to execute the code to cause the network entity to:
select the subset of PDCCH candidates to include one or more PDCCH candidates associated with an aggregation level that is less than or equal to a first threshold quantity of control channel elements (CCEs) and that is greater than or equal to a second threshold quantity of CCEs, wherein the first threshold quantity of CCEs is based at least in part on a DCI size, a first threshold coding rate associated with the range of coding rates, and a quantity of coded bits per CCE, and wherein the second threshold quantity of CCEs is based at least in part on the DCI size, a second threshold coding rate associated with the range of coding rates, and the quantity of coded bits per CCE.

22. The network entity of claim 15, wherein, to select the subset of PDCCH candidates, the one or more processors are individually or collectively operable to execute the code to cause the network entity to:
select the subset of PDCCH candidates to include one or more PDCCH candidates based at least in part on a relationship between one or more aggregation levels associated with the one or more PDCCH candidates and a nominal quantity of control channel elements (CCEs), wherein the nominal quantity of CCEs is based at least in part on a size of a payload of a DCI, a nominal coding rate, and a quantity of coded bits per CCE.

23. The network entity of claim 22, wherein the subset of PDCCH candidates includes one or more PDCCH candidates associated with a smallest aggregation level that is greater than or equal to the nominal quantity of CCEs, one or more PDCCH candidates associated with a largest aggregation level that is less than or equal to the nominal quantity of CCEs, one or more PDCCH candidates associated with one or more aggregation levels that are closest to the nominal quantity of CCEs, or any combination thereof.

24. The network entity of claim 15, wherein, to select the subset of PDCCH candidates, the one or more processors are individually or collectively operable to execute the code to cause the network entity to:
select the subset of PDCCH candidates based at least in part on a first limit of a quantity of PDCCH candidates in the subset of PDCCH candidates and a second limit of a quantity of control channel elements (CCEs) in the subset of PDCCH candidates, wherein one or more PDCCH candidates are excluded from the subset of PDCCH candidates based at least in part on a priority associated with the subset of PDCCH candidates.

25. The network entity of claim 24, wherein the one or more processors are individually or collectively further operable to execute the code to cause the network entity to:
output one or more control messages configuring the first limit of the quantity of PDCCH candidates in the subset of PDCCH candidates, the second limit of the quantity of CCEs in the subset of PDCCH candidates, or both for each search space set of the plurality of search space sets.

26. The network entity of claim 24, wherein the priority associated with the subset of PDCCH candidates is based at least in part on an aggregation level for each PDCCH candidate of the subset of PDCCH candidates and based at least in part on a candidate index for each PDCCH candidate of the subset of PDCCH candidates.

27. The network entity of claim 15, wherein the one or more processors are individually or collectively further operable to execute the code to cause the network entity to:
output one or more control messages configuring one or more parameters associated with the subset of PDCCH candidates, a first threshold coding rate, a second threshold coding rate, a nominal coding rate, or any combination thereof, wherein selecting the subset of PDCCH candidates is based at least in part on the one or more control messages.

28. The network entity of claim 15, wherein the one or more processors are individually or collectively further operable to execute the code to cause the network entity to:
obtain an indication of a capability of a user equipment (UE) for selecting and monitoring for the subset of PDCCH candidates, wherein the subset of PDCCH candidates are selected based at least in part on the capability of the UE.

29. A method for wireless communications at a user equipment (UE), comprising:
receiving one or more control messages configuring a plurality of search space sets, wherein each search space set of the plurality of search space sets is associated with one or more downlink control information (DCI) formats and a set of physical downlink control channel (PDCCH) candidates per aggregation level;
selecting, from the set of PDCCH candidates, a subset of PDCCH candidates based at least in part on a size of one or more DCI messages and one or more configurations associated with a range of coding rates; and
monitoring one or more search space sets of the plurality of search space sets based at least in part on the selected subset of PDCCH candidates.

30. A method for wireless communications at a network entity, comprising:
outputting one or more control messages configuring a plurality of search space sets, wherein each search space set of the plurality of search space sets is associated with one or more downlink control information (DCI) formats and a set of physical downlink control channel (PDCCH) candidates per aggregation level;
selecting, from the set of PDCCH candidates, a subset of PDCCH candidates based at least in part on a size of one or more DCI messages and one or more configurations associated with a range of coding rates; and
outputting a DCI in a search space set of the plurality of search space sets based at least in part on the selected subset of PDCCH candidates.
